(19) United States
(12) Patent Application Publication
(10) Pub. No.: US 2024/0284823 A1
(43) Pub. Date: Aug. 29, 2024

(54) FORESTRY MULCHING ROTARY CUTTING DEVICE WITH TILTING FEATURES

(71) Applicant: QUADCO INC., Saint-Eustache (CA)

(72) Inventors: Charles HENRICHON, Saint-Eustache (CA); Etienne MINVILLE, Saint-Eustache (CA)

(73) Assignee: QUADCO INC., Saint-Eustache, QC (CA)

(21) Appl. No.: 18/585,825

(22) Filed: Feb. 23, 2024

Related U.S. Application Data
(60) Provisional application No. 63/486,546, filed on Feb. 23, 2023.

(51) Int. Cl. A01D 34/43; A01D 34/00

(52) U.S. Cl. CPC A01D 34/43; A01D 34/005

(57) ABSTRACT

The present disclosure relates to forestry mulching or mowing heads with an upper frame and a lower frame having a rotatable cutting drum. The lower frame is pivotably mounted to the upper frame via a tilting mechanism. The tilting mechanism can include an actuator configured to pivot or tilt the lower frame relative to the upper frame. The tilting mechanism can include a bracket and a link that provides at least five independent degrees of freedom to pivot or rotate the lower frame relative to the upper frame. The tilting mechanism can provide a tilt capability of up to 180° while maintaining a pivot distance to cutting diameter ratio of less than 1 (the pivot distance being a distance between the frame pivot point and a rotational axis of the cutting drum and the cutting diameter being a diameter between cutting edges of the cutting tools on the cutting drum).

### CROSS-REFERENCE TO RELATED APPLICATIONS

This application claims priority from U.S. Provisional Patent Application Ser. No. 63/486,546 entitled “FORESTRY MULCHING ROTARY CUTTING DEVICE WITH TILTING FEATURES” filed on Feb. 23, 2023, which is incorporated by reference herein in its entirety.

### TECHNICAL FIELD

The technical field generally relates to forestry mulching rotary cutting devices. More specifically, the technical field relates to forestry mulching rotary cutting devices with a tilting mechanism.

### BACKGROUND

Mulching equipment can be used to mulch, shred, or otherwise size-reduce an organic material, such as wood, brush, or other types of vegetation. The size-reduced material is expelled from the mulcher as smaller pieces, which can be referred to as debris or chips, such as wood chips.

Conventional mulcher attachments can be coupled to the terminal end of an articulating or working arm of a vehicle. However, these conventional mulcher attachments have some drawbacks. For example, the articulating arms of different vehicles, such as different sizes of excavators or other vehicles, vary in size and configuration. These conventional mulcher attachments require a different adaptor plate for each type of vehicle that the mulcher can be used with, which can be expensive to produce, transport, and store.

Furthermore, some conventional mulcher attachments are fixedly attached to a working arm, such that the rotating drum that mulches or size-reduces the organic material has a fixed position relative to the working arm. Depending on where the opening exposing the rotary drum and the outlet for expelling the shredded debris are, the operator of the mulcher is limited in how the organic material can be approached and shredded. For example, when the opening exposing the rotary drum is on an underside, tall trees would not be able to be size reduced, as the articulating arm cannot reach a height that would allow the top of the tree to be exposed to the opening.

Other conventional mulcher attachments can provide minimal tilt by tilting the entire mulcher head relative to the articulating arm. However, these mulcher heads do not allow the frame around the cutting drum to move relative to the frame that is coupled to the articulating arm of the vehicle, thus they have a more limited range of motion and a larger vertical footprint. Other mulcher attachments are orientated laterally relative to the articulating arm (i.e., the longitudinal axis of the mulcher head is orientated in a side-to-side manner or perpendicular relative to the longitudinal axis of the articulating arm), which can reduce the impact of tilting the mulcher head.

### SUMMARY

According to one broad aspect, there is provided a mulcher head for shredding a material, the mulcher head comprising: an upper frame configured to be mountable to a movable working arm of a vehicle; a lower frame pivotably coupled to the upper frame around a frame pivot point; a tilting mechanism configured to rotate the lower frame relative to the upper frame around the frame pivot point, the tilting mechanism comprising an actuator pivotally coupled at a first end to the lower frame and at a second end to the upper frame; and a cutting drum rotationally coupled to the lower frame such that pivoting the lower frame pivots the cutting drum around an axis of the frame pivot point, wherein the cutting drum comprises cutting tools positioned around an outside thereof that are configured to shred the material.

In possible embodiments, the tilting mechanism further comprises: a bracket pivotally coupled to the first end of the actuator and pivotally coupled to the upper frame; and a link pivotably coupled to the bracket at a first end and pivotably coupled to the lower frame at a second end; and wherein the actuator is pivotally coupled to the lower frame via the bracket and the link.

In possible embodiments, the tilting mechanism comprises at least five independent degrees of freedom between the upper frame and the lower frame.

In possible embodiments, the at least five independent degrees of freedom comprises at least two independent degrees of freedom between the bracket and the first end of the link.

In possible embodiments, the at least five independent degrees of freedom comprises at least two independent degrees of freedom between the lower frame and the second end of the link.

In possible embodiments, at least one of: the pivotal connection between the link and the bracket and the pivotal connection between the link and the lower frame comprises a universal joint or a spherical joint.

In possible embodiments, the universal joint comprises a cardan joint, a hooke-type joint, a cross type joint, a cross-type with rubber bushing, a layrub coupling, or a doughnut rubber coupling.

In possible embodiments, the spherical joint comprises a universal joint having a spherical plain bearing, a spherical plain bushing, or a spherical roller bearing.

In possible embodiments, at least one of: the pivotal connection between the link and the bracket and the pivotal connection between the link and the lower frame comprises a spherical joint.

In possible embodiments, the link comprises a pivotal connection between the first end and the second end of the link.

In possible embodiments, the upper frame comprises two substantially parallel plates separated by a gap and at least a portion of the tilting mechanism is positioned within the gap.

In possible embodiments, a pivot distance to cutting diameter ratio is less than 1, wherein the pivot distance is a distance between the frame pivot point and a rotational axis of the cutting drum and the cutting diameter is a diameter between cutting edges of the cutting tools.

In possible embodiments, the pivot distance to cutting diameter ratio is between about 0.51 and about 0.70.

In possible embodiments, the actuator is pivotally coupled to an outside of the lower frame at the first end and pivotally coupled to an outside of the upper frame at the second end.

In possible embodiments, the lower frame has a tilting angle span of at least about 180° relative to the upper frame or wherein the tilting angle span is at least about 140° relative to the upper frame.

In possible embodiments, the bracket is pivotally coupled to the upper frame on a front side of the mulcher head and the actuator extends towards a rear side of the mulcher head; or the bracket is pivotally coupled to the upper frame on the rear side of the mulcher head and the actuator extends towards the front side of the mulcher head; and wherein the mulcher head is mountable to the movable working arm of the vehicle on the rear side of the mulcher head.

In possible embodiments, at least a portion of the bracket and/or the actuator is embedded in the upper frame; or an entirety of the bracket and/or the actuator is embedded in the upper frame.

In possible embodiments, a cutting side of the lower frame further comprises a guide plate configured to restrict a size of material entering between the lower frame and the cutting drum.

In possible embodiments, the mulcher head comprises a cutting side, a debris side, and an underside, wherein the cutting tools on the cutting drum are exposed on the cutting side, the debris side, and the underside, and wherein the lower frame can be tilted towards the cutting side in a cutting side tilt configuration at a cutting tilt angle of up to 80° and wherein the lower frame can be tilted towards the debris side in a debris side tilt configuration at a debris tilt angle of up to 60°.

In possible embodiments, the cutting tilt angle is up to 60° and the debris tilt angle is up to 40°.

In possible embodiments, the mulcher head may further comprise a mounting adaptor system configured to removably mount the mulcher head to the moveable working arm of the vehicle, wherein the mounting adaptor system comprises an adaptor pin comprising a pin body non-centrically coupled to a sleeve body and a coupler plate configured to couple the adaptor pin to the upper frame.

### BRIEF DESCRIPTION OF THE DRAWINGS

FIG. 1A shows a first side view of a mulcher head according to one embodiment, the mulcher head being attached to a moveable working arm of a vehicle, showing an upper frame, a lower frame, and a tilt mechanism;

FIG. 1B shows a bottom view of the mulcher head shown in FIG. 1A;

FIG. 1C shows a perspective bottom and front view of the mulcher head shown in FIG. 1A;

FIG. 1D shows a perspective bottom and second side view of the mulcher head shown in FIG. 1A;

FIG. 1E shows a perspective bottom and first side view of the mulcher head shown in FIG. 1A;

FIG. 2 shows a front view of the mulcher head shown in FIG. 1A;

FIG. 3A shows a front view of the mulcher head shown in FIG. 1A in a partial cutting-side tilt configuration, showing line A-A;

FIG. 3B shows a cross-sectional view of the mulcher head shown in FIG. 3A taken at line A-A;

FIG. 4A shows a side view of the mulcher head shown in FIG. 1A in a full cutting-side tilt configuration, showing line B-B;

FIG. 4B shows a cross-sectional view of the mulcher head shown in FIG. 4A taken at line B-B;

FIG. 4C shows an environment view of the cross-sectional view of the mulcher head shown in FIG. 4B shredding a tree and expelling debris;

FIG. 5A shows a first side view of the mulcher head shown in FIG. 1A in a debris side tilt configuration, showing line C-C;

FIG. 5B shows a cross-sectional view of the mulcher head shown in FIG. 5A taken at line C-C;

FIG. 6A shows a perspective side view of the tilting mechanism shown in FIG. 1A, including an actuator, a bracket, and a link;

FIG. 6B shows a side view of the tilting mechanism shown in FIG. 6A;

FIG. 6C shows a front view of the tilting mechanism shown in FIG. 6A;

FIG. 6D shows a front view of the tilting mechanism shown in FIG. 6A, showing line G-G;

FIG. 6E shows a cross-sectional view of the tilting mechanism shown in FIG. 6D taken at line G-G;

FIG. 7A shows a perspective side view of a tilting mechanism according to another embodiment, including an actuator, a bracket, and a link;

FIG. 7B shows a side view of the tilting mechanism shown in FIG. 7A;

FIG. 7C shows a front view of the tilting mechanism shown in FIG. 7A;

FIG. 7D shows a perspective side view of the spherical pins shown in FIG. 7B;

FIG. 8 shows a perspective side view of a mulcher head according to another embodiment, showing an upper frame, a lower frame, a tilt mechanism, and a mounting adaptor system;

FIG. 9 shows a side view of the mulcher head shown in FIG. 8;

FIG. 10 shows a front view of the mulcher head shown in FIG. 9;

FIG. 11 shows a side perspective view of a moveable working arm of a vehicle;

FIG. 12 shows a perspective side view of an upper frame according to another embodiment, showing a mounting adaptor system;

FIG. 13A shows a first side view of a mulcher head according to another embodiment, the mulcher head being attached to a moveable working arm of a vehicle, showing an upper frame, a lower frame, and a tilt mechanism;

FIG. 13B shows a rear view of the mulcher head shown in FIG. 13A, showing line A-A;

FIG. 13C shows a cross-sectional first side view of the mulcher head shown in FIG. 13B taken at line A-A;

FIG. 14A shows a cross-sectional perspective view of the mulcher head shown in

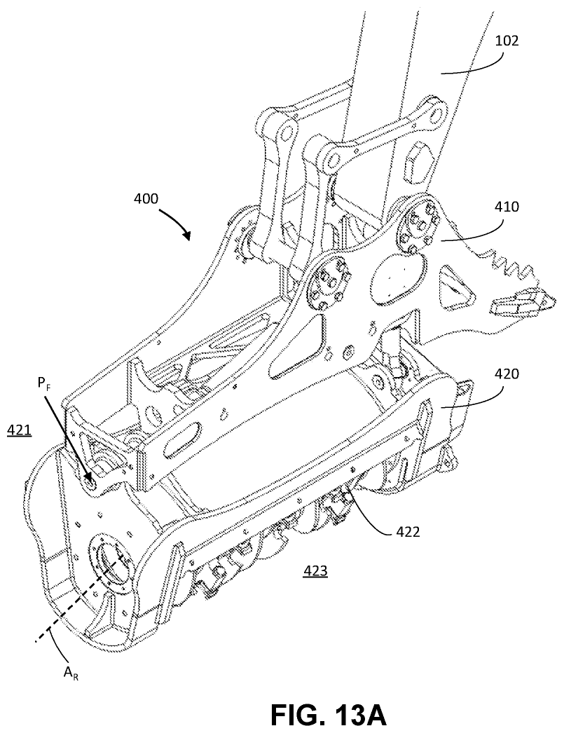

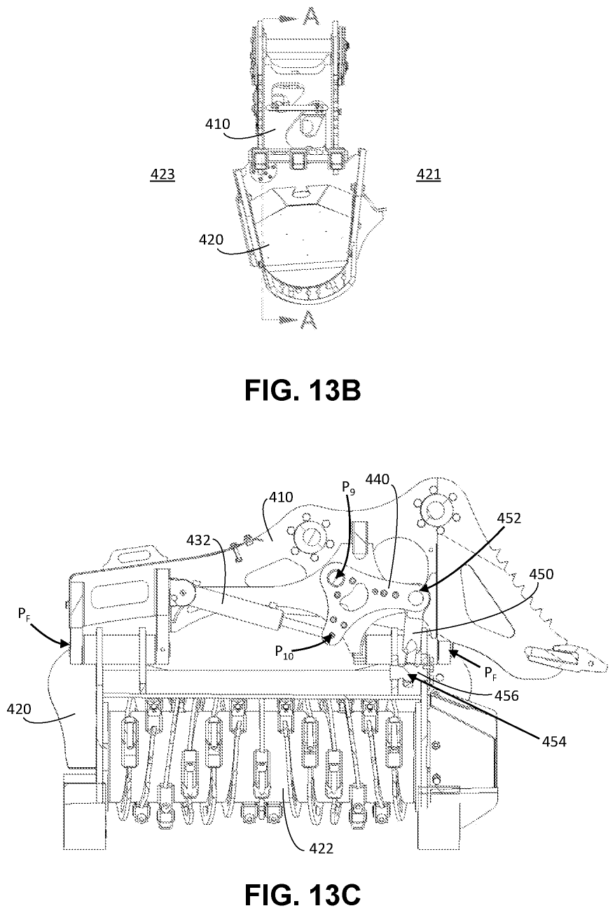

FIG. 13B taken at line A-A, showing line C-C;

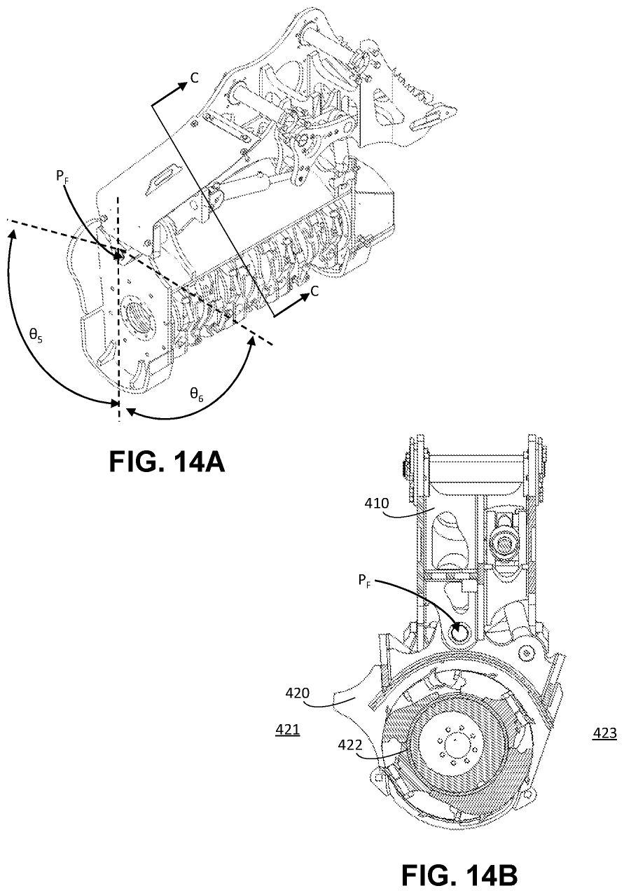

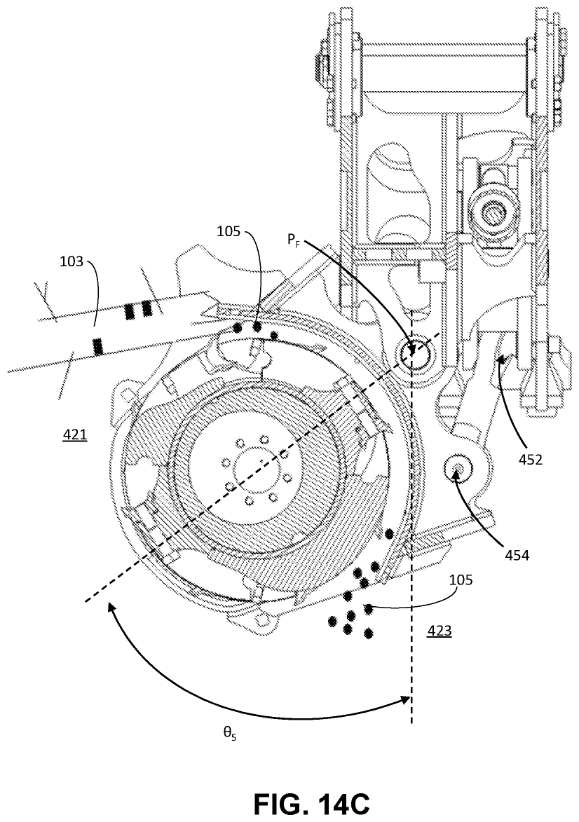

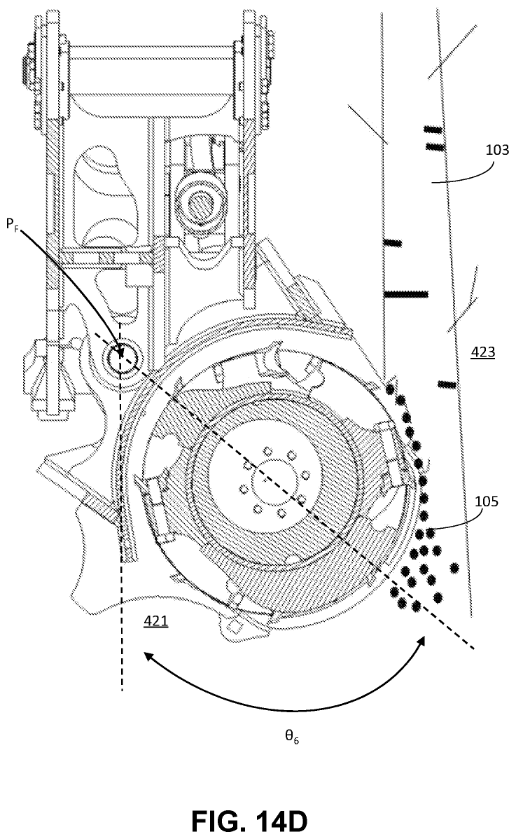

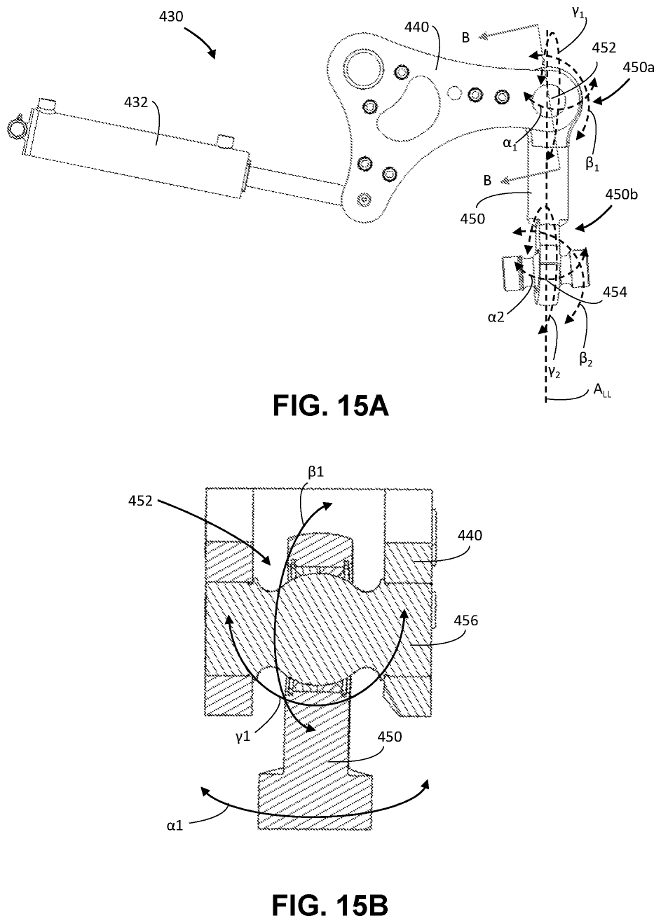

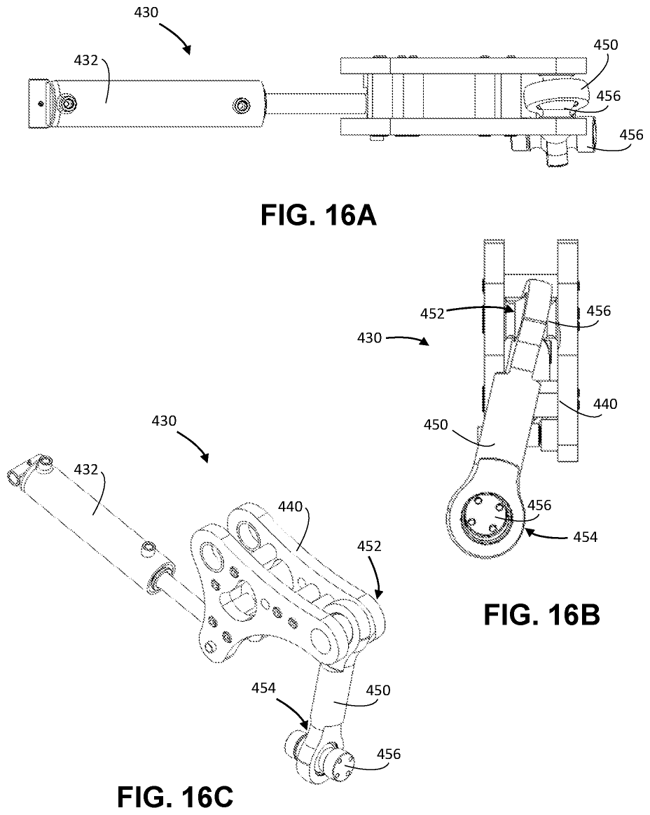

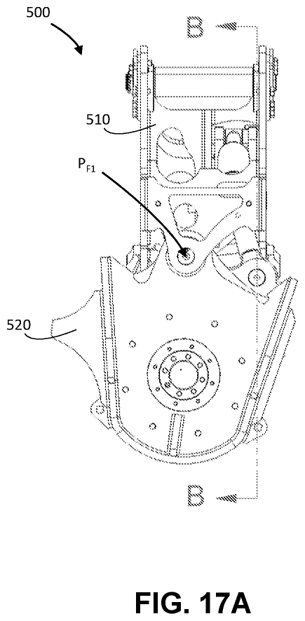

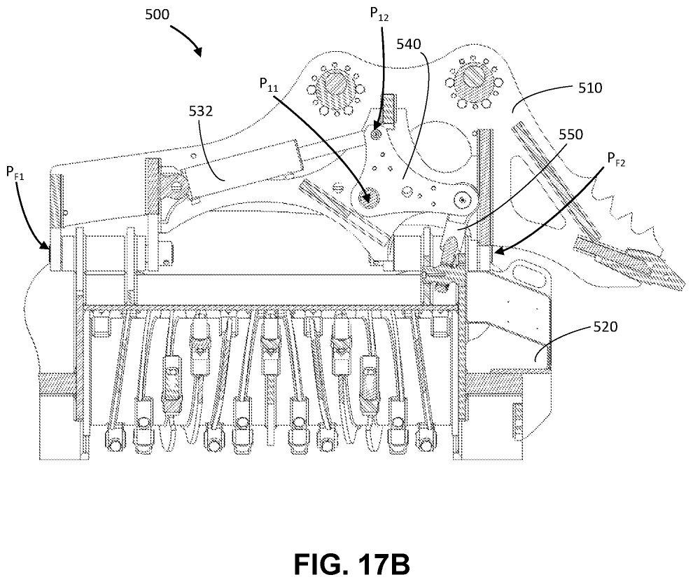

FIG. 14B shows a cross-sectional front view of the mulcher head shown in FIG. 14A taken at line C-C in a neutral or non-tilt position;

FIG. 14C shows a cross-sectional front view of the mulcher head shown in FIG. 14A taken at line C-C in a cutting side tilt configuration;

FIG. 14D shows a cross-sectional front view of the mulcher head shown in FIG. 14A taken at line C-C in a debris side tilt configuration;

FIG. 15A shows a first side view of the tilting mechanism shown in FIG. 13A isolated from the moveable working arm, the upper frame, and the lower frame, showing line B-B;

FIG. 15B shows a cross-sectional view of the tilting mechanism shown in FIG. 15A taken at line B-B;

FIG. 16A shows a top view of the tilting mechanism shown in FIG. 15A;

FIG. 16B shows a rear view of the tilting mechanism shown in FIG. 15A;

FIG. 16C shows a perspective first side view of the tilting mechanism shown in FIG. 15A;

FIG. 17A shows a front view of a mulcher head according to another embodiment, showing line B-B; and

FIG. 17B shows a cross-section first side view of the mulcher head show in FIG. 17A taken at line B-B.

### DETAILED DESCRIPTION

The present disclosure relates to forestry mulching or mowing heads that can include an upper frame that is mountable onto an articulating or movable working arm of a self-propelled vehicle, such as an excavator or loader boom, a lower frame pivotably mounted to the upper frame, and a cutting drum that is rotationally mounted to the lower frame. The cutting drum includes cutting tools that are capable of shredding a material, such as wood or brush, when the cutting drum is rotated within the lower frame. In some embodiments, the pivotal coupling between the upper frame and the lower frame is controlled with a tilting mechanism.

In some embodiments, the tilting mechanism can include an actuator configured to pivot or rotate the lower frame around a frame pivot point between the upper frame and the lower frame, such that the lower frame can be rolled or tilted relative to the upper frame. In other embodiments, the tilting mechanism can include a bracket and a link that provides at least five independent degrees of freedom to pivot or rotate the lower frame around the pivot point between the lower frame and the upper frame.

By allowing the lower frame, which houses the cutting drum, to tilt or pivot relative to the upper frame, the operator can aim the debris (i.e., shredded material) in a chosen direction as it exits the lower frame. Aiming the debris prevents it from being expelled from the lower frame towards an undesirable location, such as towards the street, surrounding buildings, or people, while the mulcher head is operated in residential or commercial areas, such as to clean roadside vegetation for power lines, land preparation for building residential or commercial buildings, etc. The tilting mechanism also allows the operator to shred or grind material from a lateral direction with respect to the longitudinal direction of the vehicle's moveable working arm. For example, when a tree is too tall to shred from the top in a vertical direction or when a controlled fall is required, the operator can tilt the lower frame in the debris side tilt configuration. The debris side tilt configuration allows the cutting drum to shred the base of the tree in the lateral direction, while the debris exits the lower frame in a downward direction, as opposed to a lateral direction.

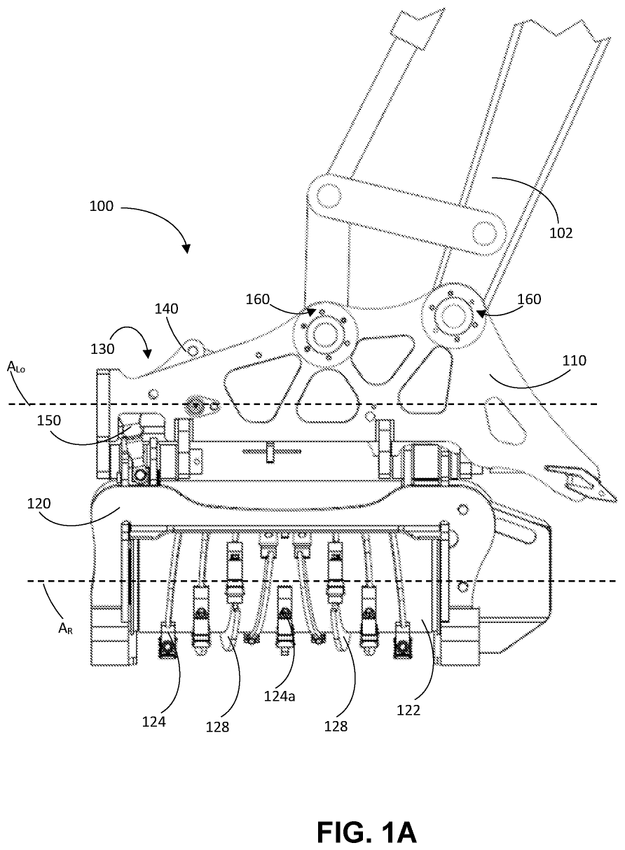

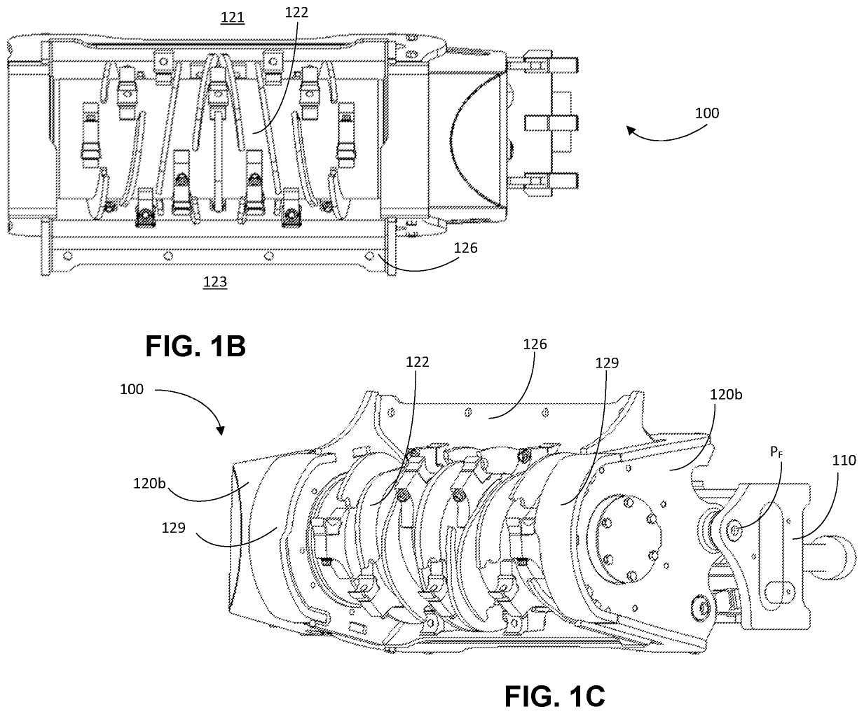

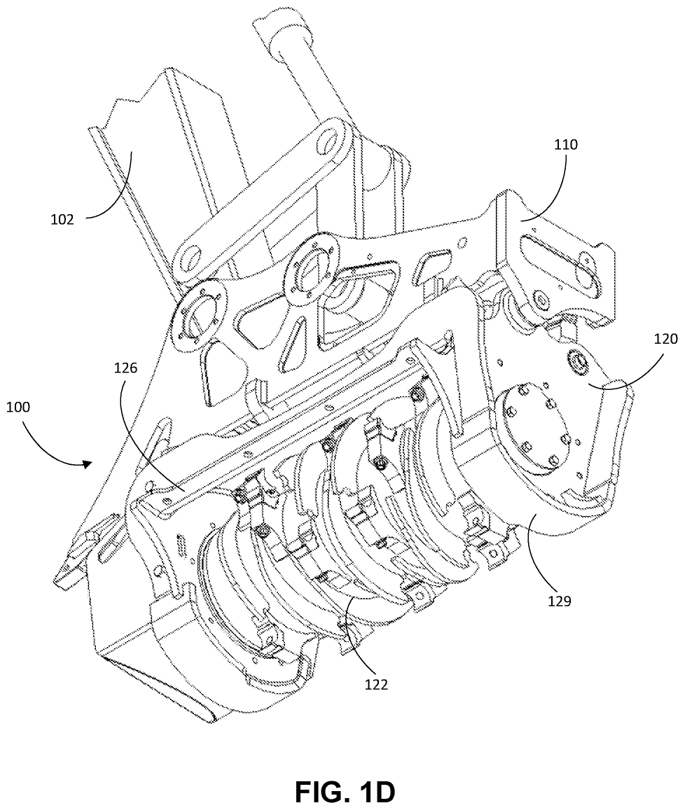

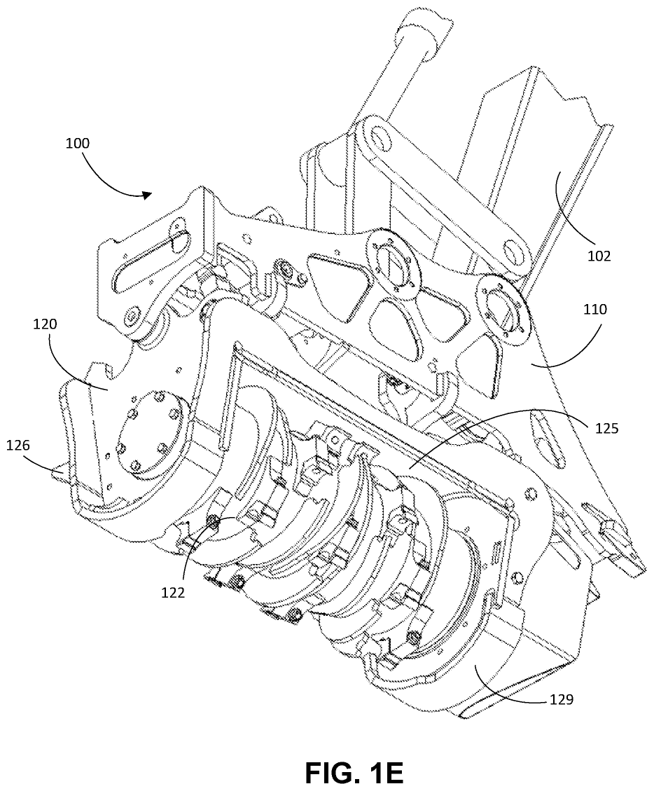

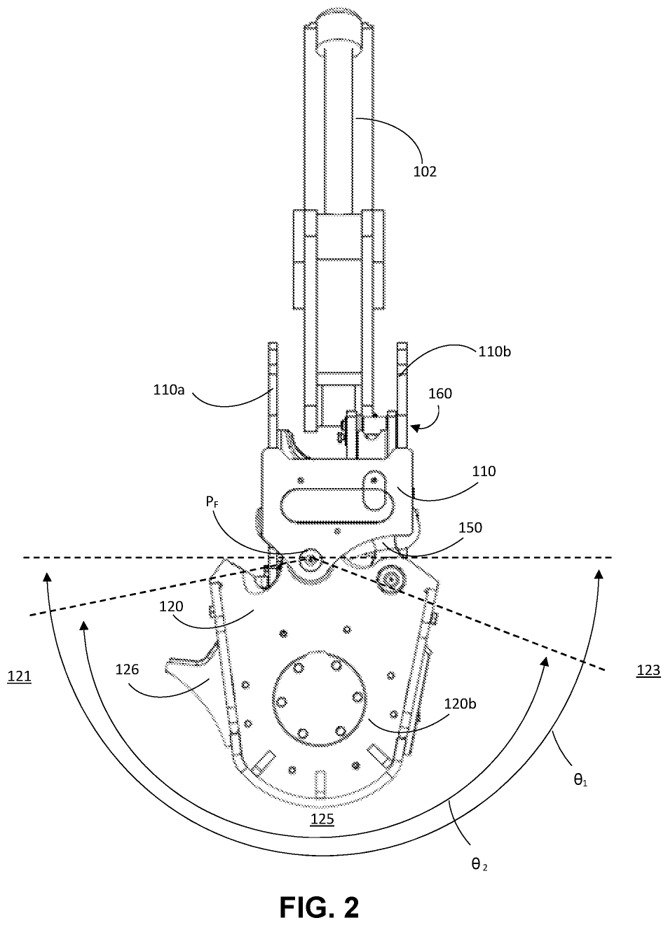

Referring to FIGS. 1A to 2, a mulcher head 100 mounted on a movable working arm 102 of a vehicle is shown. In some embodiments, the vehicle can be a self-propelled vehicle, such as an excavator or loader tractor. The mulcher head 100 includes an upper frame 110 that is configured to removably couple to the movable working arm 102 and a lower frame 120 pivotably coupled to the upper frame 110 at a frame pivot point P_{F}. The mulcher head 100 also includes a tilting mechanism 130. In the exemplary embodiment, the tilting mechanism 130 includes a bracket 140 and a link 150 located on a debris side 123 of the mulcher head 100. The tilting mechanism 130 allows the lower frame 120 to roll or pivot around the frame pivot point P_{F} having an axis extending in the same direction as the longitudinal axis A_{Lo} of the upper frame 110. In some embodiments, the tilting mechanism can be on a cutting side 121 of the mulcher head 100.

The upper frame 110 can be removably coupled to the working arm 102 in a longitudinal direction of the working arm 102 (i.e., oriented in the forward-backward direction of the moveable working arm 102). The upper frame 110 provides support for the lower frame 120 and the lower frame 120 provides structural support for a rotationally coupled rotating cutting drum 122. In the exemplary embodiment, a rotational axis A_{R} of the cutting drum 122 extends in the longitudinal direction (i.e., in the forward-reverse direction of the working arm 102). In some embodiments, the upper frame 110 includes a mounting adaptor system 160 configured to removably mount the mulcher head 100 to the movable working arm 102.

In the exemplary embodiment, the upper frame 110 includes two substantially parallel plates 110a, 110b separated by a gap 112. A portion of the bracket 140 of the tilting mechanism 130 is positioned within the gap, whereas a portion of the link 150 is positioned within or adjacent to the lower frame 120. In some embodiments, the substantially parallel plates 110a, 110b can be at an angle of up to 5°, up to 10°, up to 15°, or up to 20° with each other.

The cutting drum 122 is a tubular body comprising substantially planar ends and a curved outer surface with a plurality of tool holders 124, each configured to receive a cutting tool 124a. When the cutting drum 122 rotates, the cutting tools 124a engage with and shreds, grinds, or otherwise size-reduces the material being shredded, such as trees, shrubs, and other organic materials. Each of the plurality of cutting tools 124a are equipped with one or more sharp edges to cut and/or shred the material. In some embodiments, the cutting tools 124a are removably attached to the tool holders 124 to facilitate easier replacement and/or maintenance. The cutting tools 124a can be removably coupled to the respective tool holder 124 with a fastener, a wedge providing an interference fit, a wedge and a fastener, or other methods to removably couple the cutting tool 124a to the tool holder 124. In some embodiments, the tool holders 123 can merely be threaded or non-threaded apertures in the cutting drum 122 that are configured to receive a fastener and retain the cutting tools 124a on the cutting drum 122. In the illustrated embodiment, the tool holders 124 comprise a frame coupled to the cutting drum 122 and a wedge configured to removably couple the cutting tool 124a to the frame.

In some embodiments, the cutting drum 122 can include a bite limiter assembly 128 operatively coupled to its curved outer surface. The bite assembly 128 is configured to limit the depth of cut of the cutting tools 124a and reduce interference of the material being projected radially outward of the cutting drum 122. The bite limiter assembly 128 can comprise one or more guide plates that extend along at least a portion of the length of the drum. In possible configurations, at least some of the guide plates extend continuously along the outer surface of the cutting drum 122 at an angle to a rotational axis of the cutting drum 122. In some embodiments, the guide plates are curved in a generally helical shape. By reducing the depth of the cut of the cutting tools into the material, the guide plates reduce or prevent the cutting drum 122 from slowing down or stalling. If an amount of material is removed too quickly by the cutting tools 124a, the guide plates come into contact with the material and prevent the cutting tools 124a from cutting into the material at a deeper depth until enough material is removed, thus limiting a depth of engagement of the cutting tools 124a.

As is best shown in FIGS. 1B to 1D, the lower frame 120 includes a top side 120a and planar ends 120b that surround the tubular body of the cutting drum 122 on a top side thereof and on either planar end of the cutting drum 122, respectively. The cutting drum 122 is rotationally coupled to an inner side of the planar ends 120b of the lower frame 120. The lower frame 120 is configured such that a cutting side 121, a debris side 123, and an underside 125 of the cutting drum 120 is exposed to access the material to be shredded, such that the material can be contacted by the cutting drum 122 on either lateral side of the mulcher head 110 or on an underside 125 thereof. In some embodiments, the underside 125 of the lower frame 110 can include rotation guards 129 extending from one or both of the planar ends 120b towards a center of the cutting drum 122. The rotation guards 129 are configured to protect the rotational coupling between the lower frame 120 and the cutting drum 122.

When the lower frame 120 is tilted towards the cutting side 121 (i.e., in the cutting side tilt configuration), the cutting side 121 of the cutting drum 122 shreds the material, and the shredded material is expelled from the lower frame 120 on the debris side 123 and when the lower frame 120 is tilted towards the debris side 123 (i.e., in the debris side tilt configuration), the debris side 123 of the cutting drum 122 shreds the material, and the shredded material is expelled from the lower frame 120 on the underside 125 or the cutting side 121.

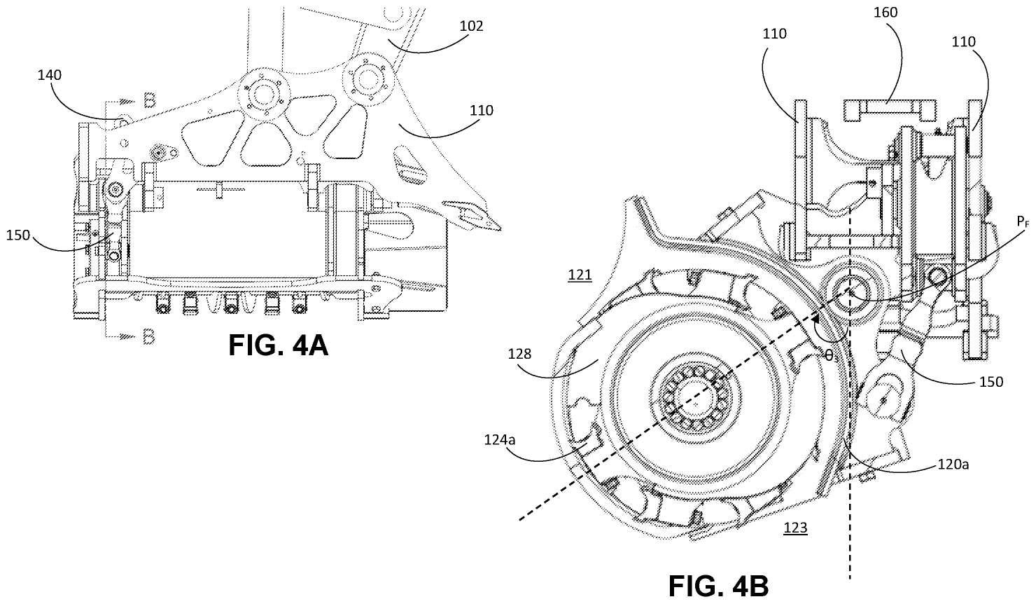

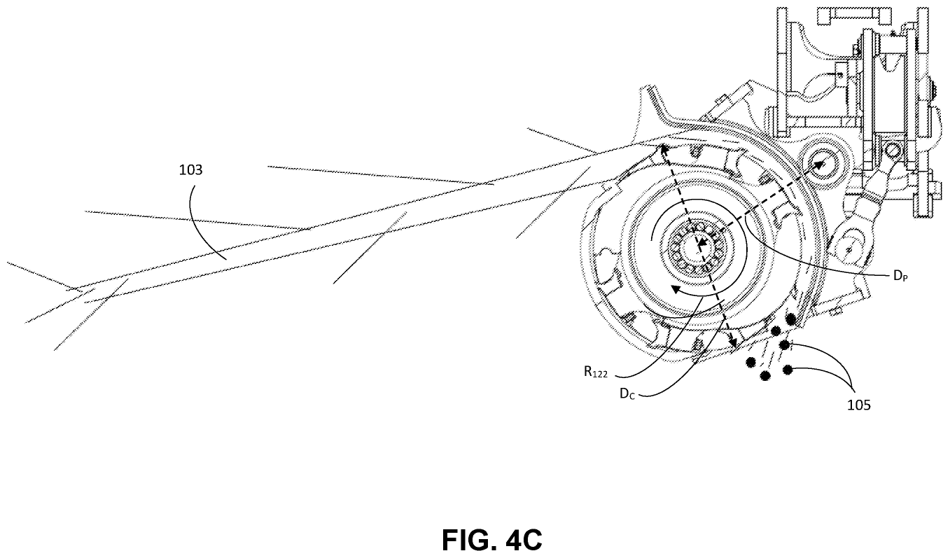

In some embodiments, the lower frame 120 includes a guide plate 126 on the cutting side 121 of the cutting drum 122. The guide plate 126 can act as a funnel to direct the material to be shredded into the lower frame 120 and restrict access to the cutting drum 122, such that material to be shredded with a larger diameter, such as a large tree, is prevented from being pulled into the lower frame 120 by the rotation R₁₂₂ of the cutting drum 122. When tilted in a full cutting side tilt configuration, such as in FIGS. 4A to 4C, a material to be shredded 103, such as a felled tree, the position of the guide plate 126 is such that the material to be shredded 103 is wedged between the guide plate 126 and the cutting drum 122. When the cutting drum 122 is rotated (i.e., when the mulcher head 300 is in operation), the material to be shredded 103 is continuously leveraged against the cutting drum 122, such that the cutting tools 124a quickly size-reduce the material to be shredded 103, while simultaneously preventing the entire material to be shredded 103 from entering the lower frame 120 and stalling the cutting drum 122. Furthermore, the direction of rotation R₁₂₂ of cutting drum 122 is such that the guide plate 126 causes the material to be shredded 103 to be continuously fed into the lower frame 120 and be size reduced by the cutting drum 122.

When the material to be shredded 103 is contacted by the cutting drum on the cutting side 121, the size-reduced debris 105 is expelled from the lower frame 120 on the debris side 123. By tilting the lower frame 120 relative to the upper frame 110 and thus the working arm 102, the operator can direct the direction of travel of the debris 105 being expelled from the debris side 123 in the lower frame 120. For example, when tilted in the cutting side tilt configuration, the top side 120a of the lower frame 120 can choke or block the debris 105, such that the debris 105 is directed vertically downwards toward the ground.

As is best shown in FIG. 4C, the tilting mechanism is embedded within the upper frame 110 and the lower frame 120, such that a ratio (D_{P}:D_{C}) between a pivot distance D_{P} and a cutting diameter D_{C} is between 0 and 1. The pivot distance D_{P} is a distance between the frame pivot point P_{F} and the rotational axis A_{R} of the cutting drum 122 and the cutting diameter D_{C} of the cutting drum 122 is the diameter between the cutting edges of opposing cutting tools 124a (i.e., the diameter from cutting edge to cutting edge). In some embodiments, the ratio (D_{P}:D_{C}) is between about 0.51 and about 0.70. In the exemplary embodiment, the pivot distance D_{P} is about 12.4 inches (31.5 cm) and the cutting diameter D_{C} is about 18.02 inches (45.72 cm), such that the ratio (D_{P}: D_{C}) is 0.69. Accordingly, the clearance of the frame pivot point P_{F} from the cutting edge of the cutting tools 124a on the cutting drum 122 is about 3.4 inches (8.64 cm), while still providing a large tilt angle span.

When the ratio (D_{P}:D_{C}) between a pivot distance D_{P} and a cutting diameter D_{C} is between 0 and 0.5, the frame pivot point P_{F} between the upper frame 110 and the lower frame 120 is between the cutting edge of the cutting drum 122 and the rotational axis A_{R} of the cutting drum's 122. For example, the frame pivot point P_{F} can be on an outer side of the planar end 120b of the lower frame 120, such that the frame pivot point P_{F} is on the planar end 120b of the lower frame 120 below the cutting edge of the cutting drum 122. In some embodiments, the frame pivot point P_{F}is in line with the rotational axis A_{R} of the cutting drum 122 (i.e., the pivot distance D_{P} is 0).

By embedding the tilting mechanism 130 in the framework of the mulcher head 100, the vertical length of the mulcher head 100 can be reduce, while still providing up to 180° of a tilt angle span. As shown best in FIG. 2, in some embodiments, the lower frame 110 can have a tilt angle span θ₁ of up to 180° relative to the upper frame 110 (i.e., tilting up to 90° on the cutting side 121 and tilting up to 90° on the debris side 123).

This large tilt angle span θ₁ can be achieved without increasing the height or vertical footprint of the mulcher head 100. In some embodiments, the tilt angle on the cutting side 121 can be larger than on the debris side 123. For example, the lower frame 110 can have a tilt angle span θ₂ of up to 140° relative to the upper frame 110, with the tilting mechanism 130 tilting the lower frame 120 towards the cutting side 121 at a tilt angle of up to 80° and tilting towards the debris side 123 at a tilt angle of up to 60°, or with the tilting mechanism 130 tilting the lower frame 120 towards the cutting side 121 at a tilt angle of up to 60° and tilting towards the debris side 123 at a tilt angle of up to 40°.

In the exemplary embodiment, the tilting mechanism 130 includes the bracket 140, the link 150, and an actuator 132. In the exemplary embodiment, the tilting mechanism 130 is hydraulically activated. The actuator 132 can be a hydraulic pump, a hydraulic cylinder, an electric rod actuator, or other known means of actuation. The actuator 132 comprises a first end 132a that is pivotably coupled to the bracket 140 at a pivot point P₁having a first pivot axis A₁ and a second end 132b that is pivotably coupled to the upper frame 110 at a second pivot point P₂having a second pivot axis A₂. When actuated, the first end 132a of the actuator 132 can extend outwardly from the second end 132b, and similarly retract towards the second end 132b, to pivotally move the bracket 140 at pivot point P₁. In addition to being pivotably coupled to the upper frame 110 via the actuator at pivot point P₁, the bracket 140 can be rotatably coupled to the upper frame 110 at a third pivot point P₃having a third pivot axis A₃.

The link 150 is pivotally coupled to the bracket 140 at a first end 150a and pivotally coupled to the lower frame 120 at a second end 150b. The first end 150a of the link 150 includes a first joint 152 that pivotally couples the bracket 140 and the link 150 and the second end 150b of the link 150 includes a second joint 154 that pivotally couples the link 150 with the lower frame 120. In some embodiments, the first and second joints 152, 154 can be universal joints, a universal joint with a spherical bearing, and/or a spherical joint. In the exemplary embodiment, the link 150 is a double joint having a universal joint as the first joint 152 and a spherical joint as the second joint 154. The second joint 154 includes a spherical plain bearing 155 to create a third degree of freedom. In some embodiments, the first and/or second joint 154 is a spherical joint or a modified universal joint that includes a spherical plain bushing 155, a spherical plain bearing, or a spherical roller bearing to create a third degree of freedom around the longitudinal axis of the link A_{LL}.

The first joint 152 includes a fourth pivot point P₄ having a fourth pivot axis A₄ that allows the link 150 to pivot in the longitudinal direction (i.e., pivoting around a lateral axis such that the link 150 moves back and forth in the longitudinal direction) relative to the bracket 140 and a fifth pivot point P₅ having a fifth pivot axis A₅ that allows the link 150 to pivot in the lateral direction (roll) relative to the bracket 140.

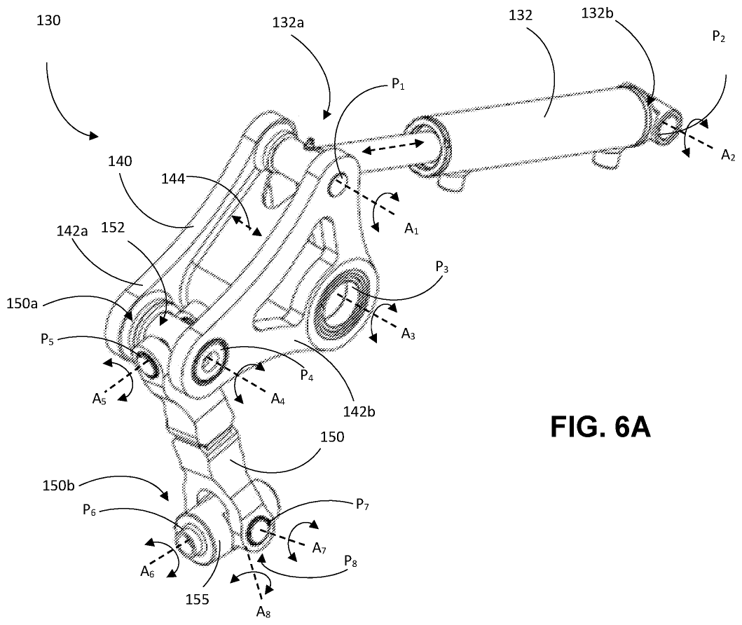

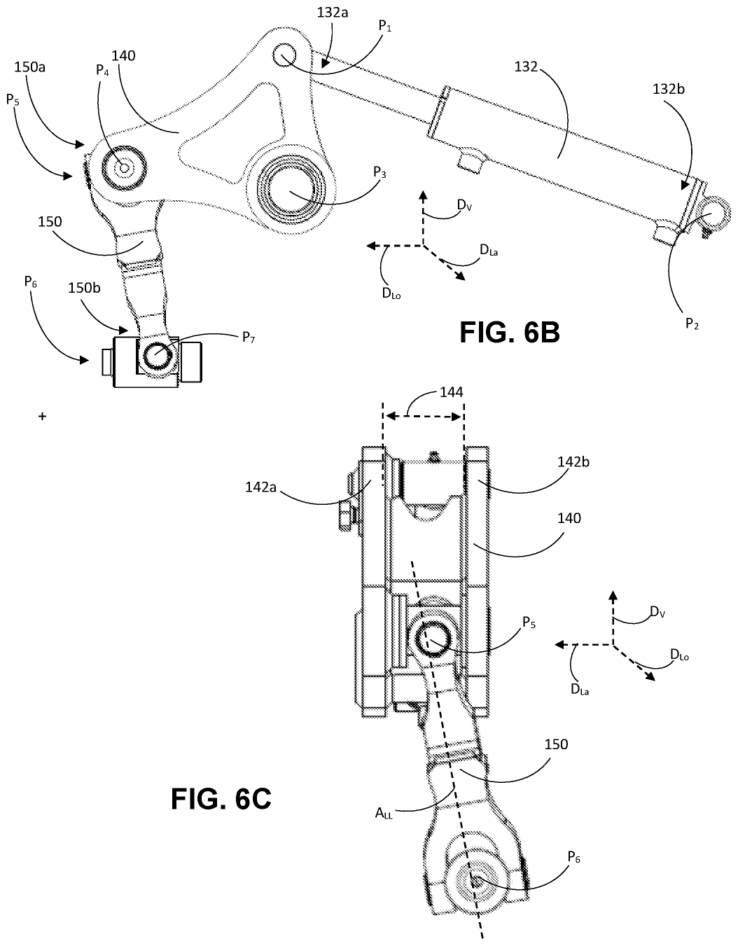

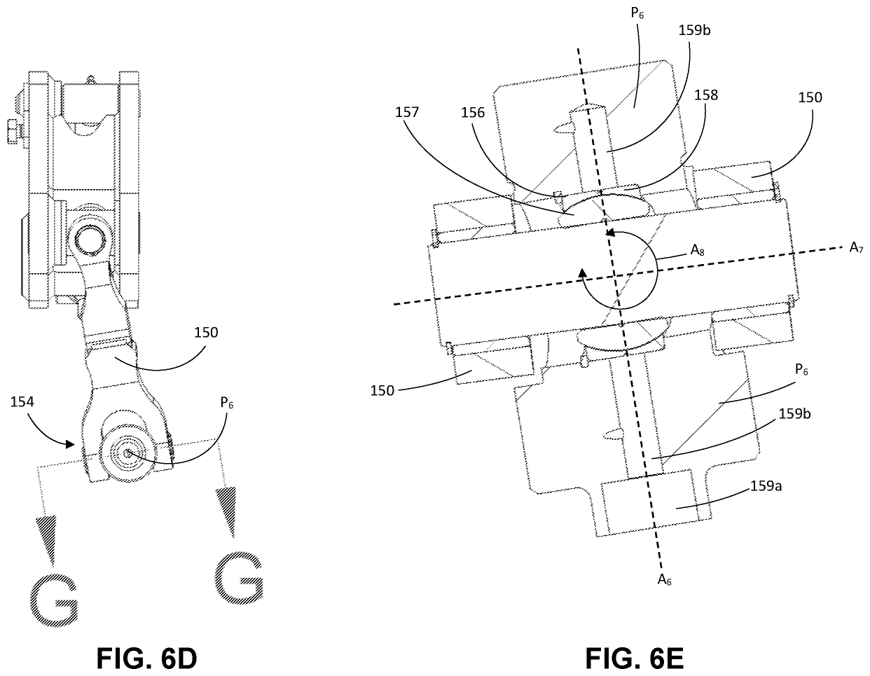

The second joint 154 includes a sixth pivot point P₆ having a sixth pivot axis A₆ that allows the lower frame 110 to pivot in the lateral direction (i.e., pivoting around a longitudinal axis of the lower frame 110 such that the lower frame 110, and thus the cutting drum 122 that shreds the material, moves side-to-side in a lateral direction) relative to the link 150 and a seventh pivot point P₇ having a seventh pivot axis A₇ that allows the lower frame 110 to pivot in the longitudinal direction relative to the link 150. In the exemplary embodiment, the second joint 154 further includes a spherical plain bearing 155 to create an eighth pivot point P₈ that rotates around an eighth axis A₈. As best shown in FIG. 6E, the spherical plain bearing 155 includes a retaining ring 156 to retain or hold the spherical plain bearing 155 in place at a center of the second joint 154, an inner race 157 and an outer race 158. In some embodiments, the second joint 154 can include a grease port 159a and grease channel 159b to grease the second joint 154.

The first and second joints 152, 154 can both be Cardan joints to create a double universal joint. Other types of universal joints can also be used, such as a Hooke-type joint, a Cross type joint (i.e., Hardy Spicer joint), a cross-type with rubber bushing, a layrub coupling, a doughnut rubber coupling, etc. In the exemplary embodiment, the first joint 152 (i.e., a cardan joint) includes a cross and yoke. The first side 150a of the link 150 includes a yoke that has apertures configured to receive two opposing sides of the cross and the bracket 140 has two apertures configured to receive the other two opposing sides of the cross. The fourth axis A₄, which extends through the apertures in the bracket 140, is perpendicular or intersecting with the fifth axis A₅, which extends through the apertures in the yoke. Similarly, the second side 150b of the linked 150 includes a yoke that has apertures configured to receive two opposing sides of the cross and the lower frame 120 has two apertures configured to receive the other two opposing sides of the cross. In the exemplary embodiment, the second joint 154 further includes a spherical plain bearing 155, to create an eighth pivot point P₈ having an eighth pivot axis P₈. The seventh axis A₇, which extends through the apertures in the yoke, is perpendicular or intersecting with both the sixth axis A₆, which extends through the apertures in the lower frame 120, and the eighth axis A₈. The eighth axis A₈ is concentric with a link longitudinal axis A_{LL} of the link 150.

The bracket 140 can be formed by two substantially parallel plates 142a, 142b separated by a gap 144, such that the first joint 152 can be housed between the two parallel plates 142a, 142b in the gap 144. In the exemplary embodiment, the bracket 140 is formed by two parallel plates 142a, 142b having a triangular shape, with each of pivot points P₁, P₃, and P₄ being at a corner of the triangle. However, other arrangements for the bracket 140 can be used. In some embodiments, the substantially parallel plates 142a, 142b can be at an angle of up to 5°, up to 10°, up to 15°, or up to 20° with each other. In some embodiments, movement around the link longitudinal axis A_{LL} is limited or restricted by the plates 142a, 142b that form the body of the bracket 140. Accordingly, the size of the gap 144 between the plates 142a, 142b that form the body of the bracket 140 can be adjusted to provide for more or less rotation around the link longitudinal axis A_{LL} of the link 150. Alternatively, the shape and/or configuration of the plates 142a, 142b that form the body of the bracket 140 can be altered to allow for more or less rotation around the link longitudinal axis A_{LL} of the link 150.

As can be seen best in FIG. 6A, in the exemplary embodiment, the tilting mechanism 130 has five degrees of freedom between the upper frame 110 and the lower frame 120. The five degrees of freedom include two degrees of freedom (pivot points P₄ and P₅) between the bracket 140 and the link 150 and three degrees of freedom (pivot points P₆, P₇, and P₈) between the link 150 and the lower frame 110.

Other configurations are envisioned; for example, the connection between the bracket 140 and the link 150 could include three degrees of freedom or rotations and the connection between the link 150 and the lower frame 110 can include two degrees of freedom or rotations. Alternatively, the connection between the bracket 140 and the link 150 could include two degrees of freedom or rotations and the connection between the link 150 and the lower frame 110 can also include two degrees of freedom or rotations. In such an embodiment, the first end 150a of the link 150 can be pivotally coupled to the second end 150b of the link 150 to provide a fifth degree of freedom, such that the second end 150b is pivotable relative to the first end 150a along a link longitudinal axis A_{LL} of the link 150.

By providing at least five degrees of freedom, a larger tilting angle span can be achieved without increasing the size of the upper frame 110 or the lower frame 120 than with a single degree of freedom (i.e. frame pivot point P_{F}). Including five degrees of freedom between the upper frame 110 and the lower frame 120 can reduce the tilting moment; however, by increasing the diameter and pressure on the actuator 132, the tilting moment can be increased.

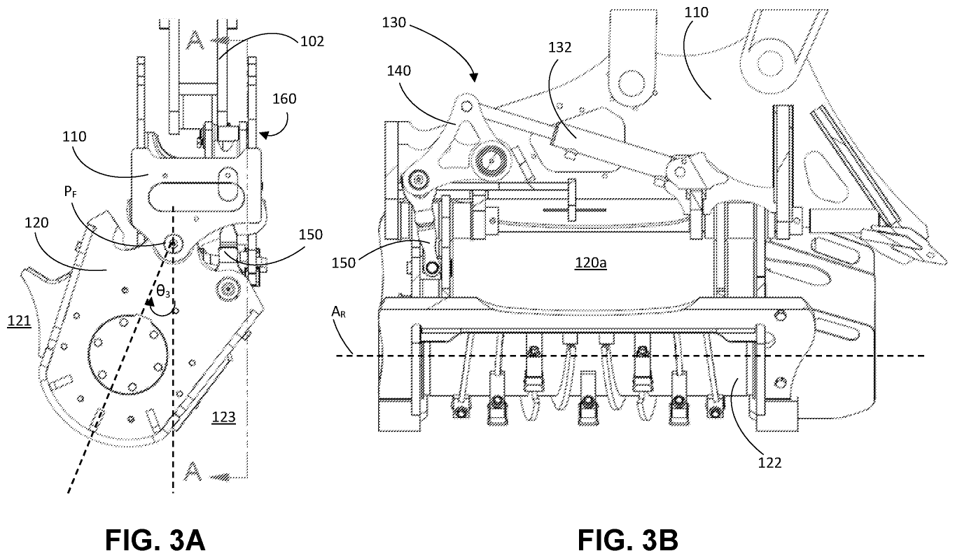

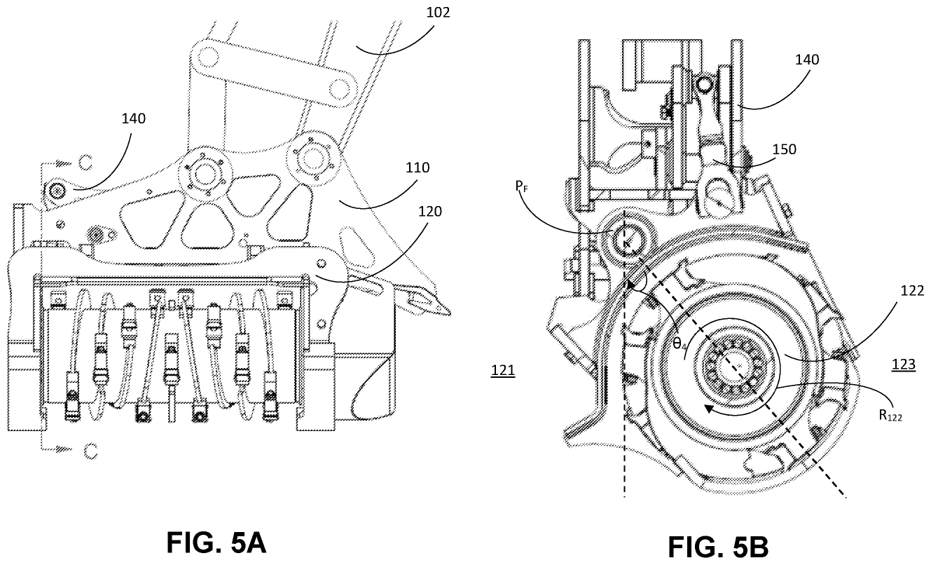

With specific reference to FIGS. 2, 3A, 4B, and 5B, the tilting angle span of the mulcher head 100 is shown. The tilting mechanism 130, when actuated, can place the mulcher head 100 in a cutting side tilt configuration (FIGS. 3A and 4B) or a debris side tilt configuration (FIG. 5B). In the cutting side tilt configuration, the lower frame 120 is tilted towards the cutting side at a tilt angle θ₃, such that exposed cutting drum 122 on the cutting side 121 is angled vertically upwards. The tilt angle θ₃ is the angle between a vertical axis extending through the frame pivot point P_{F} (i.e., an axis that extends through the frame pivot point P_{F} and a rotational axis A_{R} of the cutting drum 122 when the lower frame 110 is not tilted) and an axis extending through the frame pivot point P_{F} and a rotational axis A_{R}of the cutting drum 122. In some embodiments, the tilt angle θ₃ is between about 90° and about 20°, or between about 80° and about 60°. FIG. 3A shows a mulcher head 100 that is place in a partial cutting side tilt configuration, such that a portion of the top side 120a of the lower frame 120 is shown. FIG. 4B shows a mulcher head 100 that is tilted at a much larger angle θ₃ than the partial cutting side tilt configuration (i.e., full or substantially full cutting side tilt configuration), such that a portion of the top side 120a of the lower frame 120 is shown. As can be seen, the top side 120a of the lower frame 120 prevents the shredded debris 105 from being expelled laterally and directs the debris 105 downwardly.

When the mulcher head 100 is tilted in the debris side tilt configuration, such as shown in FIG. 5B, the lower frame 120 is tilted towards the debris side 123 at a tilt angle θ₄. In the debris side tilt configuration, the debris side 123 of the mulcher head 100 shreds the material and the debris 105 is expelled in a downwards direction. The tilt angle θ₄ is between a vertical axis through the frame pivot point P_{F} and an axis extending through the frame pivot point P_{F} and a rotational axis A_{R} of the cutting drum 122. In some embodiments, the debris side tilt configuration tilt angle θ₄ is between about 90° and about 20°, or between about 80° and about 60°.

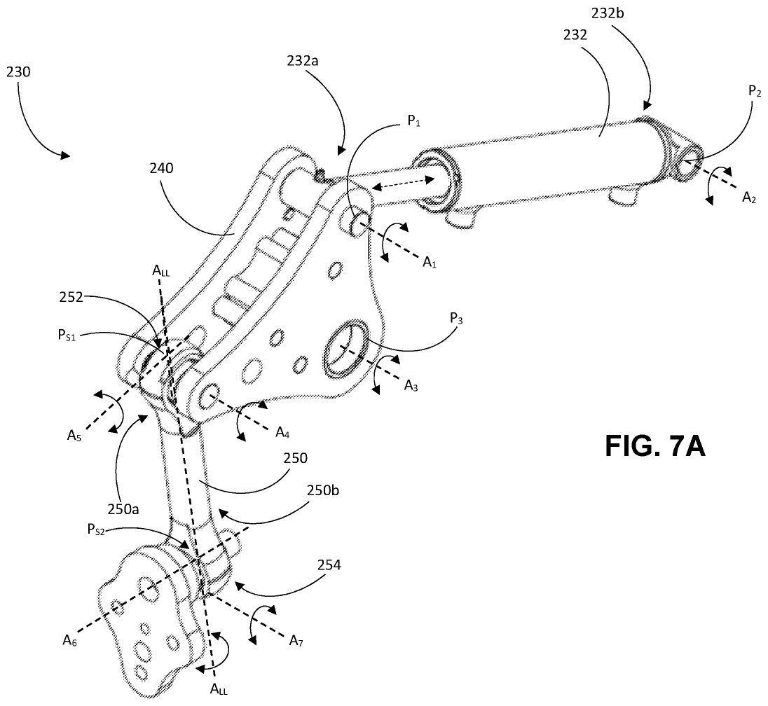

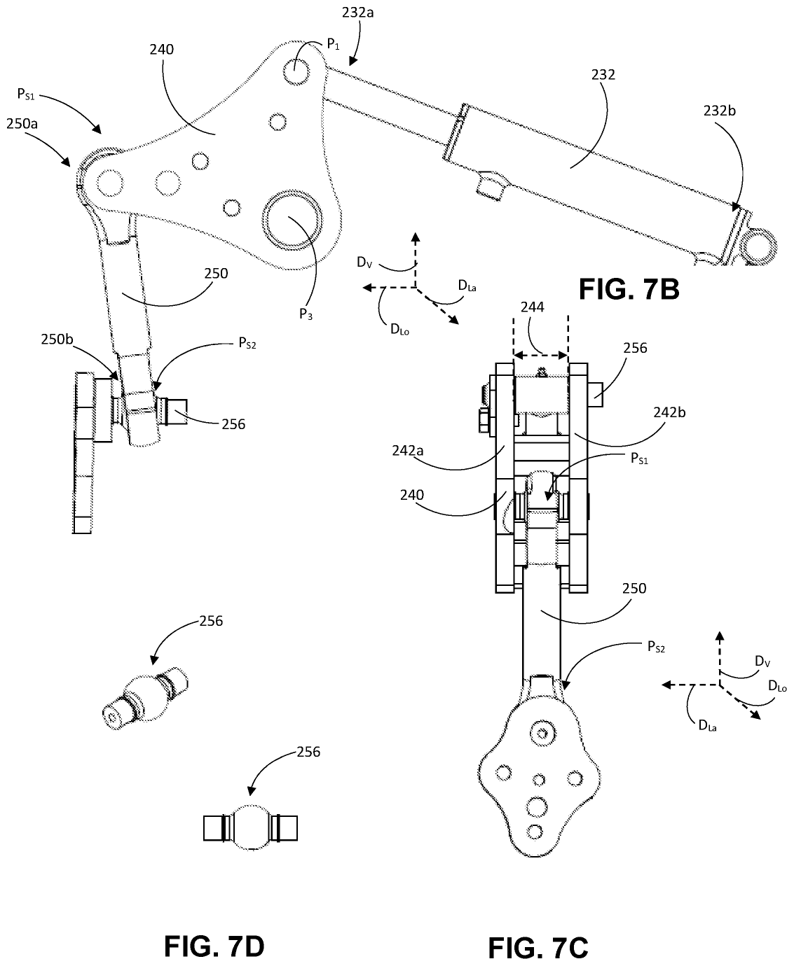

Referring now to FIGS. 7A to 7C, a tilting mechanism 230 according to another embodiment is shown. The tilting mechanism 230 comprises a bracket 240, a link 250, and an actuator 232. The actuator 232 comprises a first end 232a that is pivotably coupled to the bracket 240 at a pivot point P₁ having a first pivot axis A₁ and a second end 232b that is pivotably coupled to an upper frame of the mulcher head (such as upper frame 110) at a second pivot point P₂ having a second pivot axis A₂. The bracket 240 can be rotatably coupled to the upper frame at a third pivot point P₃ having a third pivot axis A₃.

The link 250 is pivotally coupled to the bracket 240 at a first end 150a and pivotally coupled to lower frame (such as lower frame 120) at a second end 250b. In this embodiment, the first end 250a of the link 250 includes a first joint 252 that pivotally couples the bracket 240 and the link 250 and the second end 250b of the link 250 includes a second joint 254 that pivotally couples the link 250 with a lower frame of the mulcher head (such as lower frame 120). In the exemplary embodiment, the first and second joints 252, 254 are spherical or ball joints or a universal joint with a spherical bearing or ball pin. The first and second joints 252, 254 each include a ball or spherical pin 256 extending between the two substantially parallel plates 242a, 242b that form the bracket 240. The link 250 includes a socket on each of the first end 250a and the second end 250b of the link 250, each socket being configured to receive the spherical pin 256 therethrough to create the first joint 252 and the second joint 254, respectively. In the exemplary embodiment, the first joint 252 is housed in a gap 244 between two substantially parallel plates 242a, 242b that form the bracket 240.

The first joint 252 has three degrees of freedom, allowing the link 250 to pivot at a first spherical pivot point P_{S1}having three axes of rotation; namely, a fourth pivot axis A₄ extending in the lateral direction D_{La}, a fifth pivot axis A₅ extending in the longitudinal direction D_{Lo}, and a link longitudinal axis A_{LL} of the link 250 extending through the first joint 252 and the second joint 254. The fourth pivot axis A₄, the fifth pivot axis A₅, and the link longitudinal axis A_{LL} are each perpendicular or substantially perpendicular to each other and each intersect at a centre of the first joint 252. As can be seen in FIG. 7B, the link 250 does not necessarily extend in a parallel direction to the vertical direction D_{V} and thus the link longitudinal axis A_{LL} In some embodiments, rotation around the link longitudinal axis A_{LL} is limited or restricted by the two substantially parallel side plates 242a, 242b that form the body of the bracket 240.

In this embodiment, the second joint 254 also has three degrees of freedom, allowing the link 250 to pivot at a second spherical pivot point P_{S2} having three axes of rotation: namely, a sixth pivot axis A₆ extending in the longitudinal direction D_{Lo}, a seventh pivot axis A₇ extending in the lateral direction D_{La}, and the link longitudinal axis A_{LL} of the link 250, which extends along the length of the link 250 that can extend in the vertical direction D_{V} or at an angle to the vertical direction D_{V}.

In this embodiment, the tilting mechanism 230 can have six degrees of freedom between the upper frame and the lower frame. The six degrees of freedom include three degrees of freedom between the bracket 240 (pivotally coupled to the upper frame) and the link 250 and three degrees of freedom between the link 250 and the lower frame.

Other configurations are envisioned; for example, the connection between the bracket 240 and the link 250 could include a spherical joint or ball joint to create three degrees of freedom or rotations and the connection between the link 250 and the lower frame can include a universal joint to create two degrees of freedom or rotations, for a total of five degrees of freedom. Alternatively, the connection between the bracket 240 and the link 250 could include a universal joint, whereas the connection between the link 250 and the lower frame can include a spherical joint or ball joint. In some embodiments, the connection between the bracket 240 and the link 250 can include a spherical joint and the connection between the link 250 and the lower frame can include a universal joint, or vice versa, with the link 250 having a pivot point between a first end 250a and a second end 250b thereof. Such an embodiment would create six degrees of freedom between the upper frame and the lower frame.

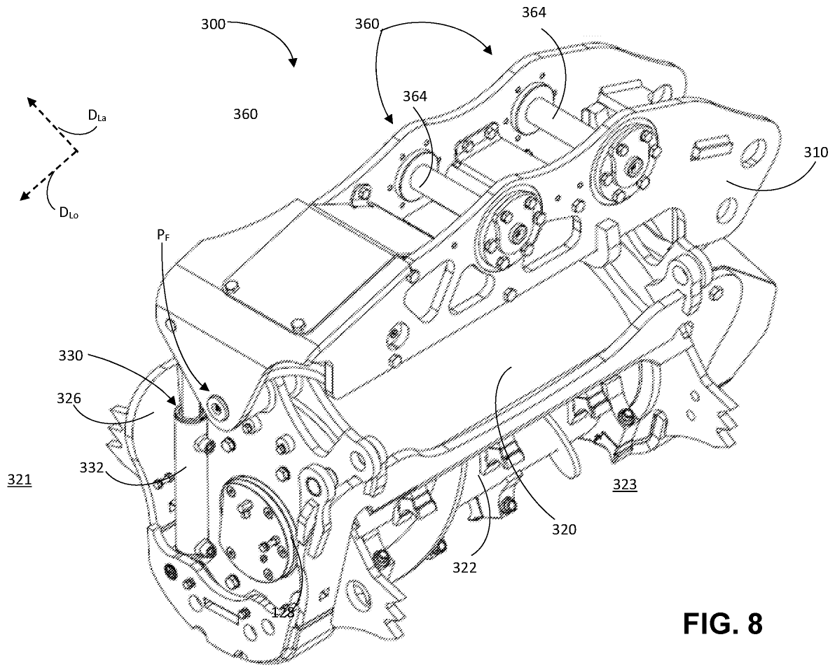

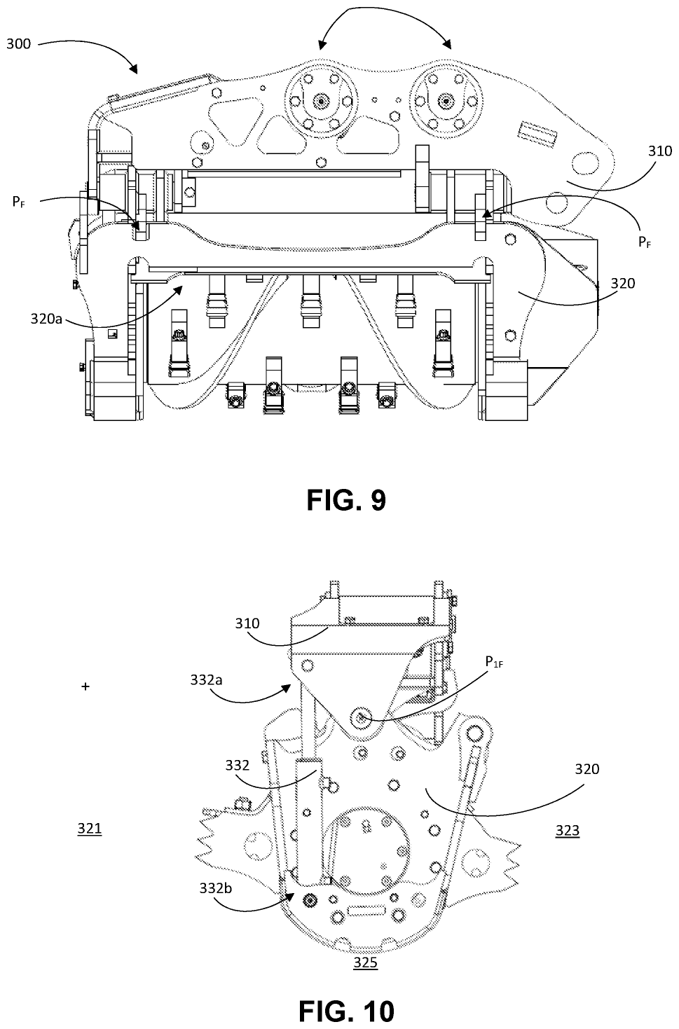

Referring now to FIGS. 8 to 10, a side view of a mulcher head 300 according to another embodiment is shown. The moving head 300 is configured to couple to a moveable working arm (not shown) of a vehicle. The mulcher head 300 includes an upper frame 310 and a lower frame 320 that is pivotably coupled to the upper frame 310 at a frame pivot point P_{F}. The mulcher head 300 further includes a tilting mechanism 330 configured to actuate and control a tilt of the lower frame 310 relative to the upper frame 320. In the exemplary embodiment, the tilting mechanism 330 includes an actuator 332 to control the pivotal connection between the upper frame 310 and the lower frame 320 at the frame pivot point P_{F}.

The lower frame 320 provides structural support for a rotationally coupled rotating cutting drum 322. In the exemplary embodiment, in addition to the cutting drum 322 being rotationally coupled to the lower frame 310, the motor (not shown) that causes the cutting drum 322 to rotate within the lower frame 320 and the bearings (not shown) that facilitate the rotation of the cutting drum 322, are coupled to the lower frame 320.

The lower frame 320 includes a topside 320a and side plates 320b at either end of the tubular body that forms the cutting drum 322. A cutting side 321, a debris side 323, and an underside 325 of the cutting drum 322 is exposed to access the material to be shredded. The cutting drum 322 is rotationally coupled to the side plates 320b. In some embodiments, the cutting side further includes a guide plate 326 that can act as a funnel to direct the material to be shredded into the lower frame 320 by restricting access to the cutting drum 322.

The upper frame 310 provides support for the lower frame 320. In the exemplary embodiment, the upper frame 310 and the lower frame 320 are pivotally connected to each other at frame pivot points P_{F} and via a pivotal coupling to each end of the actuator 332, such that the tilting mechanism 330 only includes a single degree of freedom (rotation). By pivotally coupling the lower frame 320 to the upper frame 310, when actuated by the actuator 332, the lower frame 320 can roll or tilt relative to the upper frame 310 around an axis that extends in the longitudinal direction D_{Lo} (i.e., an axis extending between the frame pivot points P_{F}). In the exemplary embodiment, the actuator 332 is a hydraulic cylinder; however, other means of actuation are possible, such as an electric rod actuator. The actuator 332 comprises a first end 332a that is pivotably coupled to the upper frame 310 and a second end 332b that is pivotably coupled to the lower frame 320.

In some embodiments, the tilting mechanism 330 can further comprise a protective shield (not shown) configured to prevent debris, such as wood, snow, dirt, rocks, etc. from entering or interfering with the tilting mechanism 330 (i.e., the frame pivot points P_{F} and/or the actuator 332).

When the actuator 332 is activated, the mulcher head 300 can move into a cutting side tilt configuration by tilting towards the cutting side 321. When in the cutting side tilt configuration, the debris travels between the top side 320a of the lower frame 320 and the cutting drum 322 and exits on the debris side 323 of the lower frame 320, which in the full cutting side tilt configuration is facing downwardly. Accordingly, when in the cutting side tilt configuration, the debris is choked or blocked from being expelled laterally from the mulcher head 300 and is thus directed downwardly. The actuator 332 can also move the mulcher head 300 into a debris configuration by tilting towards the debris side 323. When in the debris side tilt configuration, the material to be shredded is approached on the debris side 323 and the direction of rotation causes the debris to be expelled from the lower frame 320 in a downward direction on the debris side 323 or on the underside 325.

In the exemplary embodiment, the mulcher head 300 further includes a mounting adaptor system 360. The mounting adaptor system comprises bore holes in the upper frame 310 that are configured to receive an adaptor pin therethrough. The adaptor pins are configured to removably mount the mulcher head 300 to varying sizes of mounting plates on a movable working arm 102 of a vehicle.

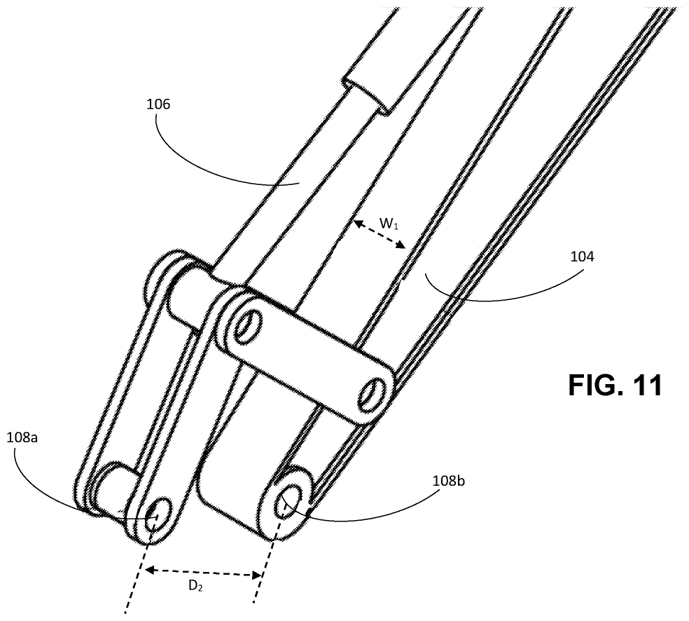

Referring now to FIG. 11, a terminal end of the movable working arm 102 is shown. The movable working arm 102 includes a boom 104 and a hydraulic cylinder 106. Depending on the size of the vehicle and/or the working arm's load capacity, the width W_{B} of the boom 104 may vary. Furthermore, each terminal end of the boom 104 and the hydraulic cylinder 106 include pin holes 108a, 108b to receive a fastener, such as a pin, to couple the boom 104 and hydraulic cylinder 106, respectfully, to the implement being attached, such as a mulcher head. Depending on the size of the vehicle, the size of the pin holes 108a, 108b, and thus the pins used in the pin holes 108a, 108b, can vary. Furthermore, the pin center to center dimension (C-to-C), which is the distance D₂ from a center of the hydraulic cylinder side pin hole 108a to a center of the boom side pin hole 108b, also varies depending on the type, size, brand, etc. of the vehicle.

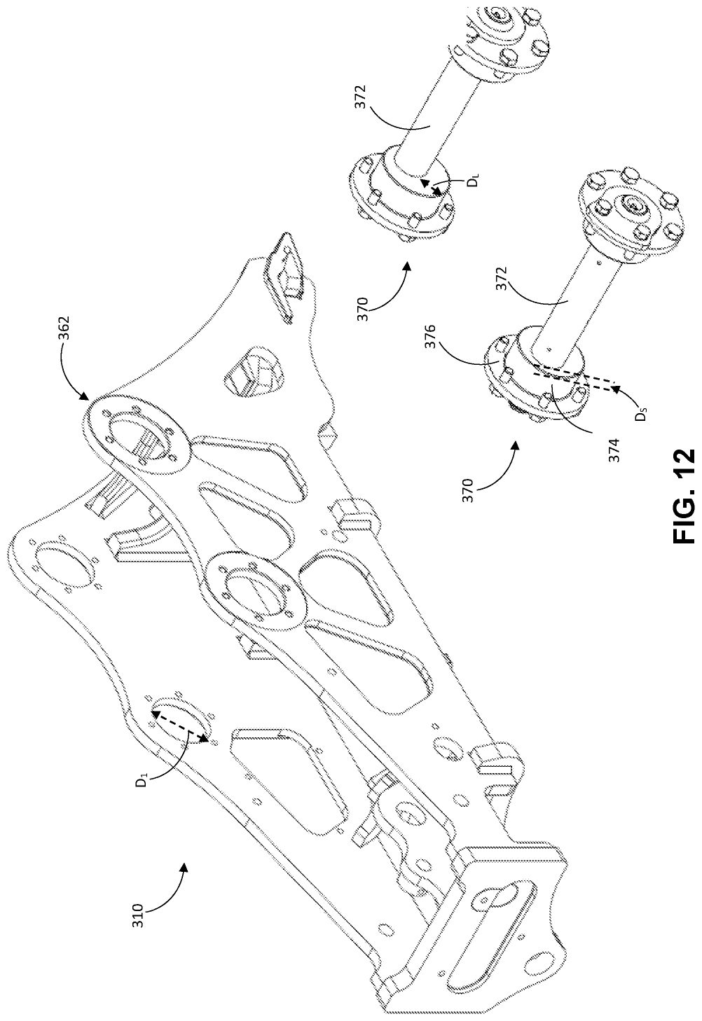

Referring now to FIG. 12, an upper frame 310 and a mounting adaptor system are shown. The mounting adaptor system includes bore holes 362 in the upper frame 310 that are configured to receive an adaptor pin 370. The bore holes 362 have a uniform diameter D₁ that is configured for use with any size working arm 102 and/or any size pin hole 108a, 108b. For example, the mounting adaptor system can be used with a working arm 102 of an about 8 ton about 35 ton excavator, such as an 8 ton, 13 ton, 15 ton, 20 ton, 25 ton, 30 ton, or 35 ton machine, including with excavators of varying brands. In some embodiments, the vehicle can be an excavator, loader, feller buncher, etc.

The adaptor pin 370 includes a pin body 372 with a sleeve body 374 and coupler plate 376 at both terminal ends of the pin body 372. The pin body 372 is configured to extend through the bore holes 362 on the upper frame and the pin holes 108a, 108b on the working arm 102 to couple the mulcher head 300 to the working arm 102 of a vehicle. The pin body 372 is secured to each of the bore holes 362 with the sleeve body 374. The pin body 372 is eccentric, acentric, or non-centric to the sleeve body 374, such that a radial distance from an outer surface of the pin body 372 to an outer surface of the sleeve body 374 varies around the outer surface of the sleeve body 374, from a smallest radial distance D_{S} to a largest radial distance D_{L}. The difference in radial distances around the outer surface of the sleeve body 374 allows for a varying C-to-C distance of the pin holes 108a, 108b. For example, to accommodate the greatest C-to-C distance, the adaptor pin 370 can extend through the bore holes 362 with the largest radial distance D_{L} on each of the adaptor pins 370 facing each other, such that the C-to-C distance equals two times the largest radial distance D_{L} distance plus the edge-to-edge distance D₂ between adjacent bore holes 362. Once positioned to have the largest radial distances D_{L} facing each other, the adaptor pins 370 can be secured in plate by coupling the coupling plate 376 to the upper frame 310, for example with known means of attachment, such as fasteners. In some embodiments, the sleeve 374 has an outer diameter that is equal to or slightly smaller than the and the diameter D₁ of the bore holes 362 on the upper frame 310, such that when the adaptor pin 370 is coupled to the bore holes 362, the sleeve 374 fits within the bore holes 362, such as with an interference fit.

By providing pin bodies 372 that are non-centric to the sleeve 374, the mounting adaptor system 360 can accommodate C-to-C distances that vary by an amount equal to twice the difference between the largest radial distances D_{L} and the shortest radial distances D_{S}. For example, if the edge-to-edge distance of the bore holes 362 is 30 cm, the largest radial distance D_{L} is 4 cm, the smallest radial distance is 2 cm, and a diameter of the pin body 372 is 6 cm, the mounting adaptor system 360 could accommodate working arms 102 with a C-to-C distance of between 40 cm and 44 cm (i.e., having a varying distance of 4 cm).

In some embodiments, the adaptor pins 370 can be adjusted to fit different boom widths W₁ by using pin bodies 372 that have a different length and diameter. For example, the same upper frame 310 can be used with two different working arms 102 on different vehicles, such as an 8 ton excavator and a 13 ton excavator, that have different boom widths W₁ by simply replacing the pin bodies 372 in the mounting adaptor system.

Referring to FIGS. 13A to 14D, a mulcher head 400 according to another embodiment is shown mounted on a movable working arm 102 of a vehicle. The mulcher head 400 includes an upper frame 410 that is configured to removably couple to the movable working arm 102 and a lower frame 420 pivotably coupled to the upper frame 410 at a frame pivot point P_{F}. The mulcher head 400 also includes a tilting mechanism 430 that allows the lower frame 420 to be tilted towards the cutting side 421 or the debris side 423. In the exemplary embodiment, the tilting mechanism 430 includes a bracket 440 and a link 450 located on the debris side 423 of the mulcher head 400. However, it is understood that the tilting mechanism 430 can be on the cutting side 421 of the mulcher head 400. The tilting mechanism 430 allows the lower frame 420 to roll or pivot around the frame pivot point P_{F} having an axis extending in the same direction as the longitudinal axis of the upper frame 410.

The mulcher head 400 is similar to the mulcher head 100 except in that the bracket 440 of the tilting mechanism 430 is located on a rear side of the mulcher head 400 and the actuator 432 extends towards a front side of the mulcher head 400. Whereas, in mulcher head 100, the bracket 140 of the tilting mechanism 130 is located on a front side of the mulcher head 100 and the actuator 432 extends towards a rear side of the mulcher head 100.

The upper frame 410 can be removably coupled to the working arm 102 in a longitudinal direction of the working arm 102 (i.e., oriented in the forward-backward direction of the moveable working arm 102). However, other configurations are possible, such as being removably coupled to the working arm 102 in a direction at an angle to or perpendicular to the longitudinal direction of the working arm. The upper frame 410 provides support for the lower frame 420 and the lower frame 420 provides structural support for a rotationally coupled rotating cutting drum 422. In the exemplary embodiment, a rotational axis A_{R} of the cutting drum 422 extends in the longitudinal direction of the working arm 102 and the vehicle (i.e., in the forward-reverse direction of the working arm 102).

Referring now to FIGS. 15A to 16C, in the exemplary embodiment, the tilting mechanism 430 includes the bracket 440, the link 450, and an actuator 432. The tilting mechanism 430 is configured to provide six degrees of freedom between the upper frame 410 and the lower frame 420. The upper frame 410 and the lower frame 420 are pivotally connected to each other at the frame pivot point P_{F}. The upper frame 410 is pivotally coupled to the tilting mechanism 430 via a pivotal coupling to the actuator 432 and a pivotal coupling to the bracket 440 (shown at pivot point P₉). The lower frame 420 is pivotally coupled to the tilting mechanism 430 via a pivotal coupling to the link 450.

In the exemplary embodiment, the tilting mechanism 430 is hydraulically activated. The actuator 432 can be a hydraulic pump, a hydraulic cylinder, an electric rod actuator, or other known means of actuation. The actuator 432 is pivotably coupled to the bracket 440 at a first end (shown at pivot point P₉) and is pivotably coupled to the upper frame 410 at a second end. When actuated, the first end of the actuator 432 can extend outwardly from the second end, and similarly retract towards the second end, to pivotally move the bracket 440 at the first end, thus moving the link 450, which moves the lower frame 420 relative to the upper frame 410.

The link 450 is pivotally coupled to the bracket 440 at a first end 450a and pivotally coupled to the lower frame 420 at a second end 450b. In this embodiment, the first end 450a of the link 450 includes a first joint 452 that pivotally (spherically) couples the bracket 440 and the link 450 and the second end 450b of the link 450 includes a second joint 454 that pivotally (spherically) couples the link 450 with the lower frame 420. The first and second joints 452, 454 each include a spherical or ball pin 456 extending between two substantially parallel plates that form the bracket 440. The link 450 includes a socket on each of the first end 450a and the second end 450b of the link 450. Each socket is configured to receive the ball pin 456 therethrough to create the first joint 452 and the second joint 454, respectively. In the exemplary embodiment, the first joint 452 is housed in a gap between the plates that form the bracket 440. In some embodiments, movement around the link longitudinal axis A_{LL} is limited or restricted by the plates that form the body of the bracket 440. Accordingly, the size of the gap between the plates that form the body of the bracket 440 (such as the gap 244 between the plates 242a, 242b shown in FIG. 7C) can be adjusted to provide for more or less alpha α₁ or alpha α₂ rotation (or rotation around the link longitudinal axis A_{LL} of the link 250 shown in FIGS. 7A to 7C). Alternatively, the shape and/or configuration of the plates that form the body of the bracket 440 can be altered to allow for more or less alpha α₁ or alpha α₂ rotation (or rotation around the link longitudinal axis A_{LL} of the link 250 shown in FIGS. 7A to 7C).

In the exemplary embodiment, the first and second joints 452, 454 are spherical joints or a cross-type universal joint with a spherical bushing or ball pin. Accordingly, in this embodiment, the link 450 is a dogbone spherical double joint that provides six degrees of freedom between the upper frame 410 and the lower frame 420 (i.e., two spherical pivots). Specifically, the first joint 452 of the link 450 provides for three degrees of freedom (i.e., rotation in the alpha α₁, beta β₁, and gamma γ₁ direction) and the second joint 454 of the link 450 provides for three degrees of freedom (i.e., rotation in the alpha α₂, beta β₂, and gamma γ₂ direction). In the exemplary embodiment, the first gamma γ₁and the second gamma γ₂ direction are synchronized together along a link longitudinal axis A_{LL} of the link 450 extending through the first joint 452 and the second joint 454. In some embodiments, other types of pivotal couplings can be used, such as a dogbone link with constant-velocity (CV) joints at one or both ends.

As is understood based on the teachings above, in the exemplary embodiment, the mulcher head 400 includes eleven (11) pivot points or axes of rotation. Namely, two frame pivot points P_{F} coupling the upper frame 410 to the lower frame 420 at both planar ends of the lower frame 420, a pivot point P₁₀ between the actuator 432 and the bracket 440, a pivot point between the actuator 432 and the upper frame 410, a pivot point P₉ between the bracket 440 and the upper frame 410, three pivot points or degrees of freedom (alpha α₁, beta β₁, and gamma γ₁) in the first joint 452, and three pivot points or degrees of freedom (alpha α₂, beta β₂, and gamma γ₂) in the second joint 454.

As can be seen best in FIG. 15A, the tilting mechanism 430 provides six degrees of freedom between the upper frame 410 and the lower frame 420. The six degrees of freedom include three degrees of freedom between the bracket 440 and the link 450 and three degrees of freedom between the link 450 and the lower frame 410. By providing six degrees of freedom, a larger tilting angle span can be achieved without increasing the size of the upper frame 410 or the lower frame 420 than with a single degree of freedom.

Referring back to FIGS. 14A to 14D, the tilting angle span of the mulcher head 400 is shown. The tilting mechanism 430, when actuated, can place the mulcher head 400 in a cutting side tilt configuration (FIG. 14C) or a debris side tilt configuration (FIG. 14D).

In the cutting side tilt configuration, as can be seen in FIG. 14C, a top side of the lower frame 420 prevents the shredded debris 105 from being expelled laterally. The debris 105 is choked by the top side of the lower frame 420, which in the cutting side tilt configuration is facing at a lateral upward angle towards the upper frame 440 and thus blocks the debris 105 from being expelled in a lateral direction. As such, the debris 105 is expelled in a downward direction. The cutting side tilt configuration further allows for large pieces of material to be shredded 103, such as a tree or tree trunk, to be processed quickly by allowing the material to be shredded 103 to be pulled into the cutting drum 422 by the rotation of the cutting drum 422. In the debris side tilt configuration, as can be seen in FIG. 14D, the material being shredded 103 is approached or shredded by the cutting drum 422 on the debris side 423 and the resulting shredded debris 105 is expelled in a downward direct on the debris side 423.

In the cutting side tilt configuration, the lower frame 420 is tilted towards the cutting side 421 at a tilt angle θ₅, such that the exposed cutting drum 422 is angled vertically upwards. The tilt angle θ₅ is the angle between a vertical axis extending through the frame pivot point P_{F} (i.e., an axis that extends through the frame pivot point P_{F} and a rotational axis A_{R} of the cutting drum 122 when the lower frame 110 is in a neutral position (not tilted)) and an axis extending through the frame pivot point P_{F} and a rotational axis A_{R} of the cutting drum 122. In some embodiments, the tilt angle θ₅ is between about 90° and about 0°, or between about 80° and about 20°. In the exemplary embodiment, the mulcher head 400 is configured to have a cutting side tilt configuration tile angle θ₅ of between 0° and about 52°.

When the mulcher head 400 is tilted in the debris side tilt configuration, such as shown in FIG. 14D, the lower frame 420 is tilted towards the debris side 423 at a tilt angle θ₆, such that the material is being shredded on the debris side 423 and debris 105 is expelled in a downwards direction on the debris side 423. The tilt angle θ₆ is between a vertical axis extending through the frame pivot point P_{F} and an axis extending through the frame pivot point P_{F} and a rotational axis A_{R} of the cutting drum 422. In some embodiments, the tilt angle θ₆ is between about 90° and 0°, or between about 80° and about 20°. In the exemplary embodiment, the mulcher head 400 is configured to provide a cutting side tilt configuration tile angle θ₆ of between 0° and about 55°. The debris tilt configuration chokes the debris 105 on the cutting side 423 and allows the operator of the cutting machine to approach material to be shredded 103 from the debris side 423.

Referring now to FIGS. 17A and 17B, a mulcher head 500 according to another embodiment is shown. The mulcher head 500 includes an upper frame 510 that is configured to removably couple to a movable working arm of a vehicle (not shown) and a lower frame 520 pivotably coupled to the upper frame 510 at a first frame pivot point P_{F1} and a second frame pivot point P_{F2}. The mulcher head 500 also includes a tilting mechanism that allows the lower frame 520 to be tilted towards a cutting side or a debris side. In the exemplary embodiment, the tilting mechanism includes a bracket 540, a link 550, and an actuator 532. When actuated, the actuator 532 pivotally moves the bracket 540, which causes the link 550 to pivot, thus pivoting the lower frame 520 around the first and second frame pivot points P_{F1}, P_{F2} relative to the upper frame 510.

In the exemplary embodiment, the tilting mechanism is substantially similar to the tilting mechanism 430 except in that the bracket 540 is rotated 180°, which allows the actuator 532 to be pinned inside the upper frame 510. In other words, as shown in FIG. 13C, the pivot point P₉ between the bracket 440 and the upper frame 410 in the mulcher head 400 is above the pivot point P₁₀ between the bracket 440 and the actuator 432. In contrast, as shown in FIG. 17B, a pivot point P₁₁ between the bracket 540 and the upper frame 510 in the mulcher head 500 is below the pivot point P₁₂ between the bracket 540 and the actuator 532. Providing the pivot point P₁₂ between the bracket 540 and the actuator 532 inside the upper frame 510 can serve to protect the actuator 532, such as a hydraulic cylinder, and the actuator's associated equipment, such as hydraulic hoses from debris from the shredded material and/or side impacts. In some embodiments, at least a portion of the bracket 540 and/or the actuator 532 is embedded in the upper frame 520. In some embodiments, an entirety of the bracket 540 and/or the actuator 532 is embedded in the upper frame 520.

Several alternative embodiments and examples have been described and illustrated herein. The embodiments of the invention described above are intended to be exemplary only. A person of ordinary skill in the art would appreciate the features of the individual embodiments, and the possible combinations and variations of the components. A person of ordinary skill in the art would further appreciate that any of the embodiments could be provided in any combination with the other embodiments disclosed herein. It is understood that the invention may be embodied in other specific forms without departing from the central characteristics thereof. The present examples and embodiments, therefore, are to be considered in all respects as illustrative and not restrictive, and the invention is not to be limited to the details given herein. Accordingly, while the specific embodiments have been illustrated and described, numerous modifications come to mind. The scope of the invention is therefore intended to be limited solely by the scope of the appended claims.

1. A mulcher head for shredding a material, the mulcher head comprising:
an upper frame configured to be mountable to a movable working arm of a vehicle;
a lower frame pivotably coupled to the upper frame around a frame pivot point;
a tilting mechanism configured to rotate the lower frame relative to the upper frame around the frame pivot point, the tilting mechanism comprising an actuator pivotally coupled at a first end to the lower frame and at a second end to the upper frame; and
a cutting drum rotationally coupled to the lower frame such that pivoting the lower frame pivots the cutting drum around an axis of the frame pivot point, wherein the cutting drum comprises cutting tools positioned around an outside thereof that are configured to shred the material.

2. The mulcher head of claim 1, wherein the tilting mechanism further comprises:
a bracket pivotally coupled to the first end of the actuator and pivotally coupled to the upper frame; and
a link pivotably coupled to the bracket at a first end and pivotably coupled to the lower frame at a second end; and
wherein the actuator is pivotally coupled to the lower frame via the bracket and the link.

3. The mulcher head of claim 2, wherein the tilting mechanism comprises at least five independent degrees of freedom between the upper frame and the lower frame.

4. The mulcher head of claim 3, wherein the at least five independent degrees of freedom comprises at least two independent degrees of freedom between the bracket and the first end of the link.

5. The mulcher head of claim 3, wherein the at least five independent degrees of freedom comprises at least two independent degrees of freedom between the lower frame and the second end of the link.

6. The mulcher head of claim 3, wherein at least one of: the pivotal connection between the link and the bracket and the pivotal connection between the link and the lower frame comprises a universal joint or a spherical joint.

7. The mulcher head of claim 6, wherein the universal joint comprises a cardan joint, a hooke-type joint, a cross type joint, a cross-type with rubber bushing, a layrub coupling, or a doughnut rubber coupling.

8. The mulcher head of claim 6, wherein the spherical joint comprises a universal joint having a spherical plain bearing, a spherical plain bushing, or a spherical roller bearing.

9. The mulcher head of claim 2, wherein at least one of: the pivotal connection between the link and the bracket and the pivotal connection between the link and the lower frame comprises a spherical joint.

10. The mulcher head of claim 2, wherein the link comprises a pivotal connection between the first end and the second end of the link.

11. The mulcher head of claim 1, wherein the upper frame comprises two substantially parallel plates separated by a gap and at least a portion of the tilting mechanism is positioned within the gap.

12. The mulcher head of claim 1, wherein a pivot distance to cutting diameter ratio is less than 1, wherein the pivot distance is a distance between the frame pivot point and a rotational axis of the cutting drum and the cutting diameter is a diameter between cutting edges of the cutting tools.

13. The mulcher head of claim 12, wherein the pivot distance to cutting diameter ratio is between about 0.51 and about 0.70.

14. The mulcher head of claim 1, wherein the actuator is pivotally coupled to an outside of the lower frame at the first end and pivotally coupled to an outside of the upper frame at the second end.

15. The mulcher head of claim 1, wherein the lower frame has a tilting angle span of at least about 180° relative to the upper frame or wherein the tilting angle span is at least about 140° relative to the upper frame.

16. The mulcher head of claim 2, wherein:
the bracket is pivotally coupled to the upper frame on a front side of the mulcher head and the actuator extends towards a rear side of the mulcher head; or the bracket is pivotally coupled to the upper frame on the rear side of the mulcher head and the actuator extends towards the front side of the mulcher head; and
wherein the mulcher head is mountable to the movable working arm of the vehicle on the rear side of the mulcher head.

17. The mulcher head of claim 16, wherein at least a portion of the bracket and/or the actuator is embedded in the upper frame; or an entirety of the bracket and/or the actuator is embedded in the upper frame.

18. The mulcher head of claim 1, wherein a cutting side of the lower frame further comprises a guide plate configured to restrict a size of material entering between the lower frame and the cutting drum.

19. The mulcher head of claim 1, wherein the mulcher head comprises a cutting side, a debris side, and an underside, wherein the cutting tools on the cutting drum are exposed on the cutting side, the debris side, and the underside, and wherein the lower frame can be tilted towards the cutting side in a cutting side tilt configuration at a cutting tilt angle of up to 80° and wherein the lower frame can be tilted towards the debris side in a debris side tilt configuration at a debris tilt angle of up to 60°.

20. The mulcher head of claim 19, wherein the cutting tilt angle is up to 60° and the debris tilt angle is up to 40°.
